(19) United States
(12) Patent Application Publication
(10) Pub. No.: US 2023/0244084 A1
(43) Pub. Date: Aug. 3, 2023

(54) HEAD-MOUNTED DEVICE

(71) Applicant: SONY GROUP CORPORATION, Tokyo (JP)

(72) Inventor: Toshimi KOBAYASHI, Kanagawa (JP)

(73) Assignee: SONY GROUP CORPORATION, Tokyo (JP)

(21) Appl. No.: 18/010,713

(22) PCT Filed: Jul. 13, 2021
(86) PCT No.: PCT/JP2021/026285

§ 371 Date: Dec. 15, 2022

(30) Foreign Application Priority Data
Jul. 21, 2020 (JP) 2020-124780

(51) Int. Cl. G02B 27/01

(52) U.S. Cl. CPC G02B 27/0176; G02B 2027/0169; G02B 2027/0154

(57) ABSTRACT

There is provided a head-mounted device mountable on a head with suitable clamping force, and including a front block, a mounting band, a pair of left and right first elastic members, and an adjustment mechanism to provide a technology such as a head-mounted device mountable on a head with suitable clamping force. The front block is mounted on a front side of a head. The mounting band has a rear block that is mounted on a rear side of the head and a pair of band portions that are mounted on left and right sides of the head and are capable of extending and contracting by relative movement between the rear block and the pair of band portions. The pair of first elastic members are provided between the front block and the pair of band portions. The adjustment mechanism is provided in the front block and adjusts initial tensile force of the pair of first elastic members by causing the pair of first elastic members to extend and contract in a state in which positions of the front block and the pair of band portions are fixed.

### TECHNICAL FIELD

The present technology relates to a technology such as a head-mounted device to be used, mounted on a user's head.

### BACKGROUND ART

In recent years, head-mounted displays capable of AR display (AR: Augmented Reality) or VR display (VR: Virtual Reality) are becoming widely known.

A head-mounted device such as a head-mounted display needs a mechanism for being mounted on a user's head. For example, a head-mounted display described in Patent Literature 1 below is a head-mounted display including a main body including a display and a mounting band for mounting the head-mounted display to a user's head.

The user can adjust clamping force on the head by rotating a dial provided in the head-mounted display.

### CITATION LIST

### Patent Literature

Patent Literature 1: WO 2016/136657

### DISCLOSURE OF INVENTION

### Technical Problem

Fearing that the head-mounted device may be deviated from the head, the user generally tends to increase the clamping force unnecessarily.

In view of the above-mentioned circumstances, it is an objective of the present technology to provide a technology such as a head-mounted device mountable on a head with suitable clamping force.

### Solution to Problem

A head-mounted device according to the present technology includes a front block, a mounting band, a pair of left and right first elastic members, and an adjustment mechanism.

The front block is mounted on a front side of a head.

The mounting band has a rear block that is mounted on a rear side of the head and a pair of band portions that are mounted on left and right sides of the head and are capable of extending and contracting by relative movement between the rear block and the pair of band portions.

The pair of first elastic members are provided between the front block and the pair of band portions.

The adjustment mechanism is provided in the front block and adjusts initial tensile force of the pair of first elastic members by causing the pair of first elastic members to extend and contract in a state in which positions of the front block and the pair of band portions are fixed.

Accordingly, it is possible to provide a head-mounted device mountable on a head with suitable clamping force.

### BRIEF DESCRIPTION OF DRAWINGS

FIG. 1 A perspective view as a head-mounted display (HMD) according to a first embodiment of the present technology is viewed from an obliquely front side.

FIG. 2 A schematic diagram as the HMD is viewed from above.

FIG. 3 An exploded perspective view as a part of an adjustment mechanism is viewed from the front side.

FIG. 4 An exploded perspective view as a part of the adjustment mechanism is viewed from a rear side.

FIG. 5 A diagram as a first rotation restriction member is viewed from the front side.

FIG. 6 A diagram showing engagement of tooth portions provided in a retaining portion with the first rotation restriction member, which is a schematic diagram as these members are viewed from the front side.

FIG. 7 A diagram showing an example of a presentation portion.

FIG. 8 An exploded perspective view as respective parts in an extension and contraction mechanism are viewed from the rear side.

FIG. 9 An exploded perspective view as respective parts of the extension and contraction mechanism are viewed from the front side.

FIG. 10 A perspective view as a rear dial and a second rotation restriction member are viewed from the front side.

FIG. 11 A perspective view as the rear dial and a clutch are viewed from the rear side.

FIG. 12 A diagram as the rear dial and a pair of lock levers are viewed from the rear side.

FIG. 13 A perspective view as the rear dial and the lock levers are viewed from the rear side.

FIG. 14 A schematic cross-sectional view of respective parts of the extension and contraction mechanism in a horizontal plane (XY-plane), which is a diagram showing switching between an unlocked state and a locked state.

FIG. 15 A diagram showing a state when a user is adjusting initial tensile force by rotating a front dial through the adjustment mechanism before the user wears the HMD on the head.

FIG. 16 A diagram showing states of the rear dial, the lock levers, and the like when the rear dial is rotated in a clockwise direction (as viewed from the rear side).

FIG. 17 A perspective view from the rear side, showing a state when stopper hooks of the lock levers lock protrusions of the rear dial.

FIG. 18 A schematic diagram of the HMD as a state when a pair of first spring members are caused to extend by a constant amount are viewed from above.

FIG. 19 A side view of the HMD, showing a state when a pair of first spring members 1 are caused to extend by the constant amount.

### MODE(S) FOR CARRYING OUT THE INVENTION

Hereinafter, embodiments according to the present technology will be described with reference to the drawings.

### First Embodiment

<Overall Configuration and Configurations of Respective Parts>

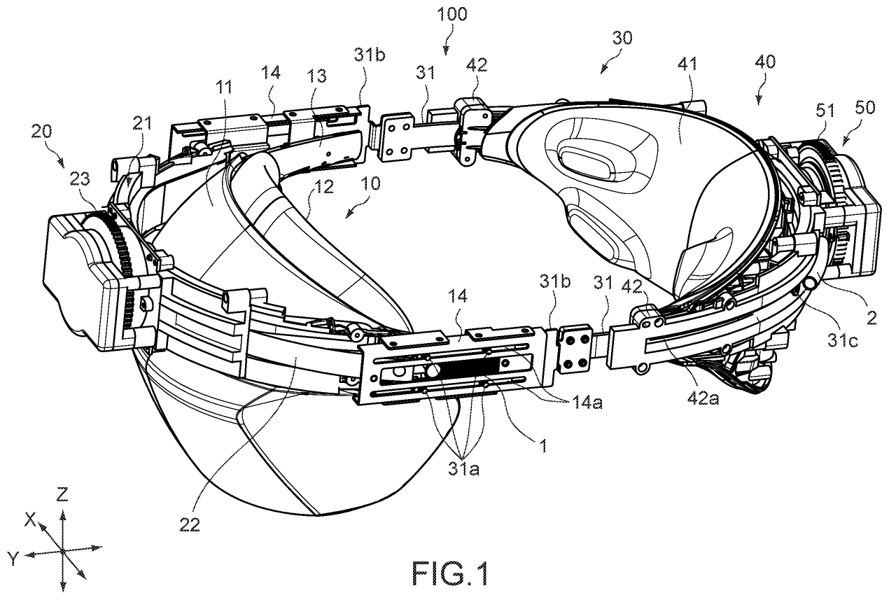

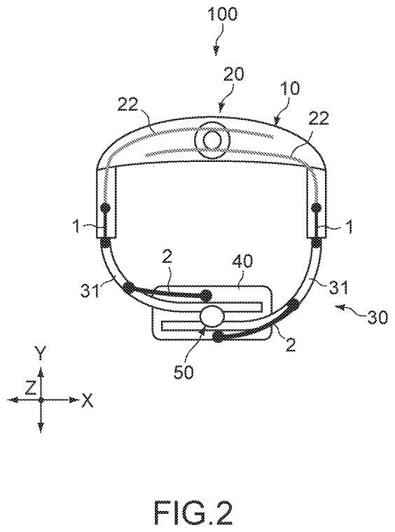

FIG. 1 is a perspective view as a head-mounted display (HMD) 100 according to a first embodiment of the present technology is viewed from an obliquely front side. In FIG. 1, a rear part of the HMD 100 is represented, partially broken. FIG. 2 is a schematic diagram as the HMD 100 is viewed from above.

In the description of the embodiment, the HMD 100 will be described as an example of a head-mounted device to which a mounting mechanism according to the present technology is applied. On the other hand, the head-mounted device is not limited to the HMD 100. For example, the head-mounted device may be an electroencephalographic (EEG) measurement device for measuring brain waves or may be headphones. Typically, the head-mounted device can be any device as long as it is a device wearable on a user's head.

In each figure of the present embodiment, the Y-axis direction denotes a front-rear direction, the X-axis direction denotes a left-right direction, and the Z-axis direction denotes an upper-lower direction. Moreover, in the description of the present embodiment, a direction around the axis of the front-rear direction (Y-axis direction) is defined as a circumferential direction and a direction perpendicular to the front-rear direction (Y-axis direction) is defined as a radial direction. Moreover, the inside in the radial direction is defined as an inner peripheral side and the outside in the radial direction is defined as an outer peripheral side.

As shown in FIGS. 1 and 2, the HMD 100 generally has an annular shape and is mounted to cover the user's head (around the Z-axis).

The HMD 100 includes a front block 10 that is mounted on a front side of the user's head and a mounting band 30 that is mounted from the sides to the back of the user's head. The mounting band 30 is configured to surround the sides of the head and the back of the head. The mounting band 30 includes a rear block 40 that is mounted on the rear side of the head and a pair of left and right band portions 31 that are mounted on left and right sides of the head. The mounting band 30 is capable of extending and contracting by relative movement between the rear block 40 and the pair of band portions 31.

Moreover, the HMD 100 includes a pair of left and right first spring members 1 capable of pulling a pair of band portions 31 of the mounting band 30 toward the front block 10 and a pair of left and right second spring members 2 that generate tensile force to cause the mounting band 30 to contract.

It should be noted that although springs will be described as an example of elastic materials used for a first elastic member and a second elastic member in the description of each embodiment, the elastic materials are not limited to the springs and may be rubbers or the like.

Moreover, the HMD 100 includes an adjustment mechanism 20 that is provided on the side of the front block 10 and adjusts the initial tensile force F₀ of the pair of first spring members 1 by causing the pair of first spring members 1 to extend and contract in a state in which the positions of the front block 10 and the pair of band portions 31 are fixed.

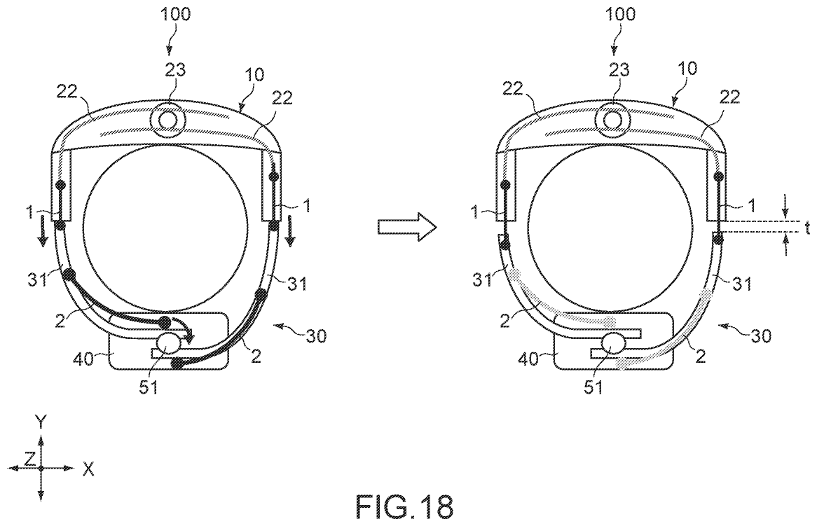

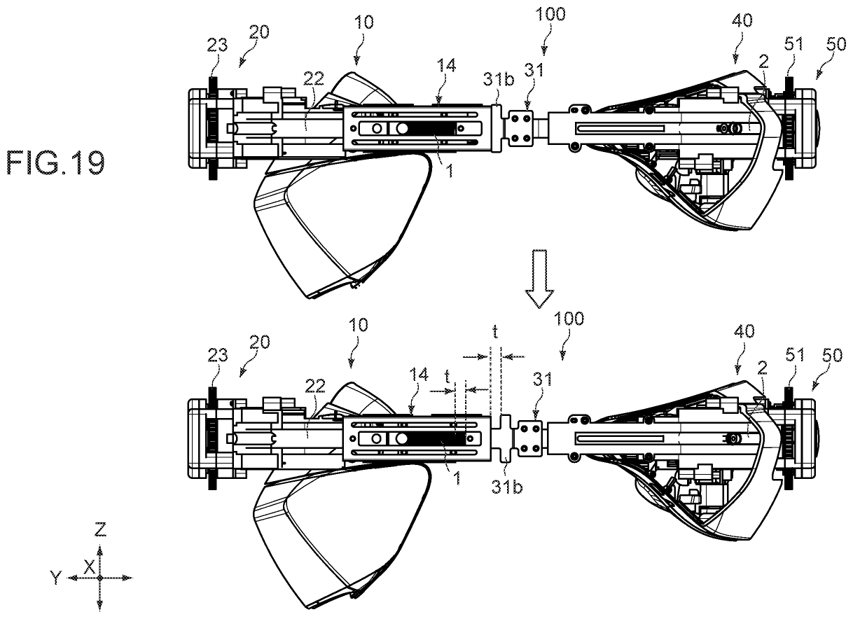

Moreover, the HMD 100 includes an extension and contraction mechanism 50 that is provided on the side of the rear block 40 and is for causing the pair of band portions 31 to extend and contract with respect to the rear block 40. This extension and contraction mechanism 50 is configured to be capable of causing the pair of first spring members 1 in which the initial tensile force F₀ is produced to extend by the constant amount t by causing the pair of band portions 31 to contract with respect to the rear block 40 by a constant amount t (regarding the constant amount t, see FIGS. 18 and 19 to be described later). By causing each of the pair of first spring members 1 to contract by the constant amount t in this manner, final clamping force F of the HMD 100 is determined.

Here, in the description of the present embodiment, the terms, the “initial tensile force F₀” and the “final clamping force F”, are used as the following meanings.

The “initial tensile force F₀” means tensile force of the pair of first spring members 1 each adjusted in a state in which the positions of the front block 10 and the pair of band portions 31 are fixed. It should be noted that although a median of the initial tensile force F₀ is set to be 4.54 N in the present embodiment, this value can be changed as appropriate.

On the other hand, the “final clamping force F” means clamping force on the head, which is produced from the entire HMD 100 by causing the pair of first spring members 1 in which the initial tensile force Fc is produced to further extend the constant amount t (see FIGS. 18 and 19 to be described later). It should be noted that although the median of the final clamping force F is set to be about 10 N in the present embodiment, this value can be changed as appropriate.

[Front Block 10]

The front block 10 includes a front block main body 11 and a forehead pad 12 provided on an inner upper side of the front block main body 11. It should be noted that a display unit capable of performing VR display or AR display is provided in the inside of the front block main body 11.

Moreover, the front block 10 includes a pair of left and right fixing portions 13 provided on the sides of both left and right ends of the front block main body 11 and a pair of left and right coupling portions 14 fixed to the pair of fixing portions 13.

The front block main body 11 is formed, curved at a predetermined curvature (around the Z-axis) to be easily mounted on the head. The position of forehead pad 12 is set to come into contact with the forehead when the user wears the HMD.

The pair of fixing portions 13 are provided extending rearward from both left and right end portions of the front block main body 11.

The pair of coupling portions 14 are fixed to the pair of fixing portions 13. The pair of coupling portions 14 are members for coupling the mounting band 30 to the front block 10. The coupling portions 14 are constituted by thin plate shapes and are capable of housing therein the first spring members 1 and front end portions of the band portions 31.

The coupling portion 14 has two guide grooves 14a provided in the front-rear direction at the upper and lower positions. The two guide grooves 14a are capable of guiding four protrusions 31a provided at each of the front end portions of the band portions 31 in the front-rear direction, and accordingly, the coupling portions 14 are capable of guiding the front end portions of the band portions 31 in the front-rear direction.

[Adjustment Mechanism 20]

The adjustment mechanism 20 is provided on the side of the front block 10. The adjustment mechanism 20 adjusts the initial tensile force F₀ of the pair of first spring members 1 by causing the pair of first spring members 1 to extend and contract in a state in which the positions of the front block 10 and the pair of band portions 31 are fixed. The adjustment mechanism 20 includes a retaining portion 21, a pair of left and right link members 22, and a front dial 23 (first dial).

“Retaining Portion 21”

The retaining portion 21 is formed to be curved in a U-shape. Both end sides of the retaining portion 21 are fixed to the coupling portions 14. This retaining portion 21 is configured to be capable of retaining respective parts of the adjustment mechanism 20. In particular, this retaining portion 21 is capable of rotatably retaining the front dial 23 and is configured to be capable of guiding the pair of link members 22 along the curved U-shape.

“Link Member 22”

The pair of link members 22 are capable of extending and contracting by rotation of the front dial 23 and are configured to be capable of adjusting the initial tensile force F₀ of the pair of first spring members 1 due to its extension and contraction.

The pair of link members 22 each have a shape like a band long in one direction. The pair of link members 22 are capable of extending and contracting in synchronization by the same length while being guided by the U-shaped retaining portion 21 on the side of the front block 10.

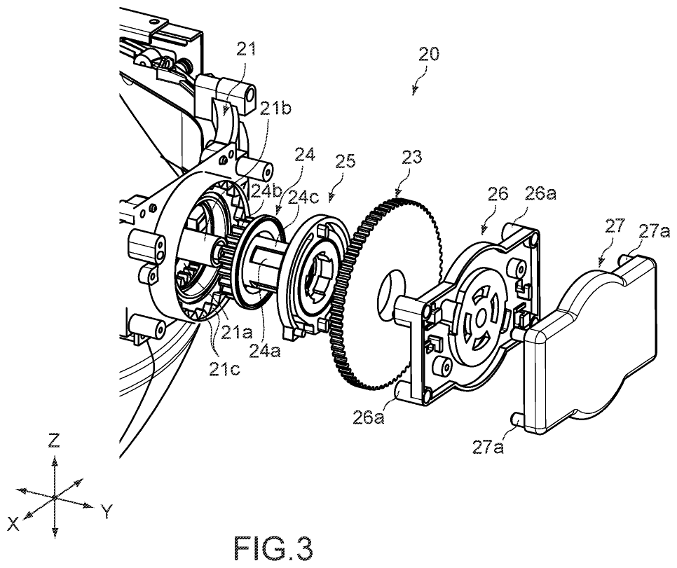

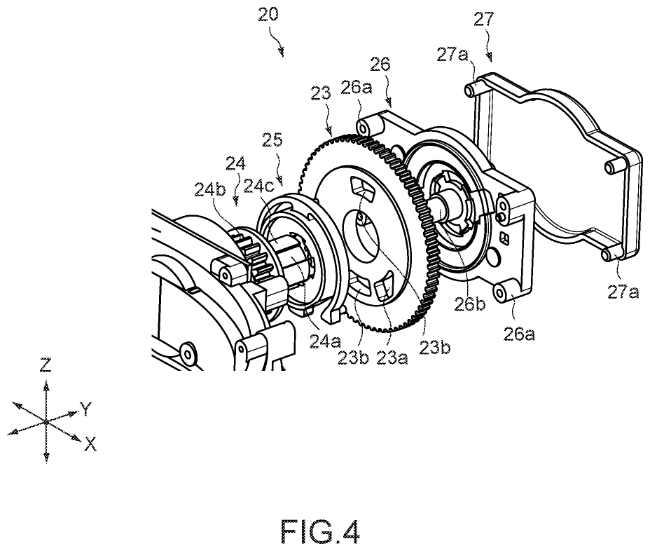

Racks are provided in certain regions on front end sides of the pair of link members 22. These racks are formed to be capable of being engaged with a first pinion gear 24b that rotates in accordance with the rotation of the front dial 23 (see FIGS. 3 and 4 to be described later).

On the other hand, the rear end sides of the pair of link members 22 are fixed to the front end sides of the pair of first spring members 1, respectively. For this reason, when the pair of link members 22 extend and contract, the pair of first spring members 1 extend and contract in accordance with this extension and contraction, and accordingly, the initial tensile force F₀ is adjusted. Specifically, when the pair of link members 22 contract, the pair of first spring members 1 extend and the initial tensile force F₀ of each of the pair of first spring members 1 increases. On the contrary, when the pair of link members 22 extend, the pair of first spring members 1 contract and the initial tensile force F₀ of each of the pair of first spring members 1 decreases.

“Configurations of Front Dial 23, etc.”

FIG. 3 is an exploded perspective view as a part of the adjustment mechanism 20 is viewed from the front side. FIG. 4 is an exploded perspective view as a part of the adjustment mechanism 20 is viewed from the rear side. As shown in FIGS. 3 and 4, the adjustment mechanism 20 further includes a first pinion gear portion 24, a first rotation restriction member 25 (restriction member), a first cover member 26, a second cover member 27, and the like.

Here, in the present embodiment, the front dial 23, the first rotation restriction member 25, and the first pinion gear portion 24 are configured to be rotatable around the front-rear axis and the expressions, clockwise and counter-clockwise, are used for rotations of the respective parts of the adjustment mechanism 20. For the sake of convenience, it is assumed that the expressions, clockwise and counter-clockwise, as rotation directions of the respective parts of the adjustment mechanism 20 mean rotation directions as viewed from the front side.

“Opening, etc. in Retaining Portion 21”

A circular opening 21a is provided at a center position of the retaining portion 21 in the left-right direction (in particular, see FIG. 3). The first pinion gear portion 24, the first rotation restriction member 25, the front dial 23, the first cover member 26, and the second cover member 27 are assembled and attached at the position of the opening 21a in order from the rear side.

The retaining portion 21 includes a shaft portion 21b extending in the front-rear direction at a center position of the opening 21a. The shaft portion 21b is capable of supporting the first pinion gear portion 24, the first rotation restriction member 25, and the front dial 23 as the shaft.

Moreover, the retaining portion 21 has a plurality of tooth portions 21c formed in the form of a V-shaped gear over its entire circumference on a circular inner peripheral surface formed by the opening 21a (also see FIG. 6 to be described later). The plurality of tooth portions 21c is capable of locking the first rotation restriction member 25.

Although the number of tooth portions 21c is 24 and their pitch is 15 degrees in the present embodiment, they can be changed as appropriate.

“First Pinion Gear Portion 24”

The first pinion gear portion 24 is supported by the shaft portion 21b provided in the retaining portion 21. The first pinion gear portion 24 is configured to be rotatable in both the clockwise and counter-clockwise directions (as viewed from the front side) around the front-rear axis. The first pinion gear portion 24 includes a circular tube portion 24a and the first pinion gear 24b fixed on the rear side of the tube portion 24a.

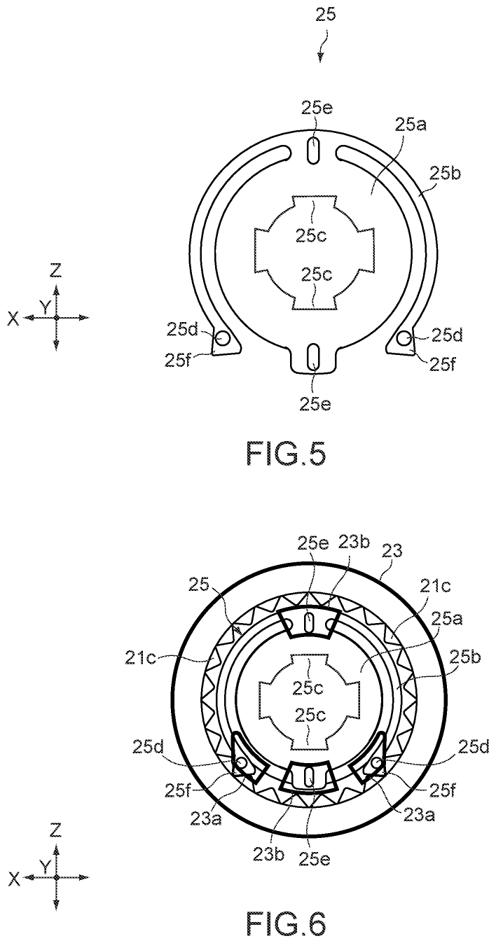

The tube portion 24a of the first pinion gear portion 24 includes a plurality of convex portions 24c at constant intervals in the circumferential direction in the outer circumferential surface. The plurality of convex portions 24c is configured to be capable of being fitted in a plurality of recess portions 25c provided in the first rotation restriction member 25 (see FIGS. 5 and 6).

The plurality of convex portions 24c of the first pinion gear portion 24 and the plurality of recess portions 25c of the first rotation restriction member 25 are fitted to each other. Therefore, in the present embodiment, the first pinion gear portion 24 and the first rotation restriction member 25 are integral in the rotation direction.

The first pinion gear 24b is capable of being engaged with racks provided in the pair of link members 22 and is capable of causing the pair of link members 22 to extend and contract by the rotation thereof. Although the first pinion gear 24b has a pitch circle diameter of Φ20 in the present embodiment, this value can be changed as appropriate.

“First Rotation Restriction Member 25”

FIG. 5 is a diagram as the first rotation restriction member 25 is viewed from the front side. FIG. 6 is a diagram showing engagement of the tooth portions 21c provided in the retaining portion 21 with the first rotation restriction member 25, which is a schematic diagram as these members are viewed from the front side. It should be noted that in FIG. 6, the front dial 23 on the front side is expressed with the thick solid line and the front dial 23 is shown in a see-through manner.

Referring to FIGS. 5 and 6, the first rotation restriction member 25 includes an annular ring portion 25a positioned on the inner peripheral side and a U-shaped U-portion 25b that is located on the outer peripheral side and formed like a partially cut annular ring. The U-portion 25b is formed to be concentric with the ring portion 25a, and is connected with the ring at the center position in the circumferential direction.

The ring portion 25a includes the plurality of recess portions 25c on the side of its inner peripheral surface. The recess portions 25c are configured to be capable of being fitted to the convex portions 24c of the first pinion gear portion 24.

Moreover, the ring portion 25a includes a pair of second ribs 25e at a position connected to the U-portion 25b and a position on the opposite side of that position across the center of the ring portion 25a. The pair of second ribs 25e are provided to project forward (toward the front dial 23) in a front surface of the ring portion 25a. The pair of second ribs 25e are capable of being engaged with a pair of second groove portions 23b provided in the dial.

The U-portion 25b includes, at the both end portions thereof, a pair of hook portions 25f and a pair of first ribs 25d. The pair of hook portions 25f are provided so as to protrude toward the outer peripheral side. The pair of hook portions 25f are formed in a V-shape and are capable of being engaged with the V-shaped tooth portions 21c formed in the opening of the retaining portion 21. The pair of hook portions 25f are biased toward the outer peripheral side in the state engaged with the tooth portions 21c, using the point connected to the ring portion 25a as the support point.

The pair of first ribs 25d are provided so as to protrude forward (toward the front dial 23) at positions in the front surface of the U-portion 25b, which correspond to the pair of hook portions 25f. The pair of first ribs 25d are capable of being engaged with a pair of first groove portions 23a provided in the front dial 23.

Although the first rotation restriction member 25 is rotatable in both the clockwise and counter-clockwise directions around the front-rear axis, the rotation in one direction of the clockwise and counter-clockwise directions is restricted in an engaged state in which one hook portion 25f of the pair of hook portions 25f is engaged with the tooth portions 21c.

It will be described with reference to FIG. 6. When the hook portion 25f on the right-hand side in FIG. 6 is engaged with the tooth portions 21c, the clockwise rotation (as viewed from the front side) of the first rotation restriction member 25 is restricted. It should be noted that the hook portion 25f on the left-hand side in FIG. 6 does not prevent the clockwise rotation (as viewed from the front side). Moreover, when the hook portion 25f on the left-hand side in FIG. 6 is engaged with the tooth portions 21c, the counter-clockwise rotation (as viewed from the front side) is restricted. It should be noted that the hook portion 25f on the right-hand side in FIG. 6 does not prevent the counter-clockwise rotation (as viewed from the front side).

Here, during non-rotation of the front dial 23, the hook portions 25f of the first rotation restriction member 25 and the tooth portions 21c of the retaining portion 21 are put in an engaged state and the rotation of the first rotation restriction member 25 is restricted, and accordingly, the extension and contraction of the pair of link members 22 are restricted. On the other hand, during the rotation of the front dial 23, the engagement of the hook portions 25f of the first rotation restriction member 25 with the tooth portions 21c of the retaining portion 21 is cancelled in accordance with the rotation of the front dial 23, and accordingly, the extension and contraction of the pair of link members 22 are allowed.

That is, the first rotation restriction member 25 is capable of allowing the extension and contraction of the pair of link members 22 that are performed in accordance with a rotation of the front dial 23 while restricting the extension and contraction of the pair of link members 22 that are not performed in accordance with a rotation of the front dial 23.

Here, since the rear end sides of the pair of link members 22 are fixed to the front end sides of the first spring members 1 as described above, force in a direction to extend is constantly added to the pair of link members 22. On the other hand, the motion of the pair of link members 22 to extend due to tensile force of the pair of first spring members 1 is restricted by the first rotation restriction member 25 as the extension and contraction of the pair of link members 22 that are not performed in accordance with a rotation of the front dial 23.

That is, during non-rotation of the front dial 23, since the hook portions 25f of the first rotation restriction member 25 are engaged with the tooth portions 21c of the retaining portion 21, the first rotation restriction member 25 does not rotate and the first pinion gear portion 24 in which the first rotation restriction member 25 and the rotation direction are integral does not rotate. The pair of link members 22 having racks that are engaged with the first pinion gear 24b of the first pinion gear portion 24 do not extend and contract as long as the first pinion gear portion 24 does not rotate. Therefore, the motion of the pair of link members 22 to extend due to the first spring members 1 is restricted by the first rotation restriction member 25.

“Front Dial 23”

The front dial 23 is capable of adjusting the initial tensile force F₀ due to its rotation. The front dial 23 is rotatable in both the clockwise and counter-clockwise directions (as viewed from the front side) around the front-rear axis.

The front dial 23 includes the pair of first groove portions 23a at positions corresponding to the pair of first ribs 25d of the first rotation restriction member 25 in the back surface thereof (surface on the side of the first rotation restriction member 25). Moreover, the front dial 23 includes the pair of second groove portions 23b at positions corresponding to the pair of second ribs 25e of the first rotation restriction member 25 in the back surface thereof. The pair of first groove portions 23a are capable of being engaged with the pair of first ribs 25d and the pair of second groove portions 23b are capable of being engaged with the pair of second ribs 25e.

One first groove portion 23a of the pair of first groove portions 23a (on the right-hand side in FIG. 6) is formed so that one end portion of both end portions of the groove in the circumferential direction (an end portion positioned in the counter-clockwise direction (as viewed from the front side) from the center of the groove) is inclined at a predetermined angle with respect to the radial direction. The inclination of the one end portion of the groove is inclination in the clockwise direction (as viewed from the front side) with respect to the radial direction.

Accordingly, the one first groove portion 23a is capable of moving one first rib 25d (on the right-hand side in FIG. 6) toward the inner peripheral side in accordance with the clockwise rotation of the front dial 23 (as viewed from the front side) and cancelling the engaged state with the tooth portions 21c of the retaining portion 21 due to one hook portion 25f (on the right-hand side in FIG. 6) of the first rotation restriction member 25.

The other first groove portion 23a (on the left-hand side in FIG. 6) of the pair of first groove portions 23a is formed so that one end portion of both end portions of the groove in the circumferential direction (an end portion positioned in the clockwise direction (as viewed from the front side) from the center of the groove) is inclined at a predetermined angle with respect to the radial direction. The inclination of the one end portion of the groove is inclination in the counter-clockwise direction (as viewed from the front side) with respect to the radial direction.

Accordingly, the other first groove portion 23a is capable of moving the other first rib 25d (on the left-hand side in FIG. 6) in accordance with the counter-clockwise rotation (as viewed from the front side) of the front dial 23 toward the inner peripheral side and cancelling the engaged state with the tooth portions 21c of the retaining portion 21 due to the other hook portion 25f (on the left-hand side in FIG. 6) of the first rotation restriction member 25.

Moreover, the pair of first groove portions 23a lock the pair of first ribs 25d of the first rotation restriction member 25 when the front dial 23 is rotated by a predetermined angle (e.g., 15 degrees), so as to be capable of rotating the first rotation restriction member 25 integrally with the rotation of the front dial 23.

The pair of second groove portions 23b of the front dial 23 have a fan shape. The pair of second groove portions 23b lock the pair of second ribs 25e of the first rotation restriction member 25 when the front dial 23 is rotated by a predetermined angle (e.g., 15 degrees), so as to be capable of rotating the first rotation restriction member 25 integrally with the rotation of the front dial 23.

Here, the second ribs 25e of the first rotation restriction member 25 and the second groove portions 23b of the front dial 23 are provided for support to prevent load from concentrating on the pair of first ribs 25d and damaging the pair of first ribs 25d when the first rotation restriction member 25 and the first pinion gear portion 24 rotate in accordance with a rotation of the front dial 23.

When the front dial 23 is rotated in the clockwise direction (as viewed from the front side), the first rotation restriction member 25 and the first pinion gear portion 24 rotate integrally in the clockwise direction, and accordingly, the pair of link members 22 contract. On the other hand, when the front dial 23 is rotated in the counter-clockwise direction (as viewed from the front side), the first rotation restriction member 25 and the first pinion gear portion 24 rotate integrally in the counter-clockwise direction, and accordingly, the pair of link members 22 extend.

“First Cover Member 26”

The first cover member 26 is formed in a table shape having four leg portions 26a (see FIGS. 3 and 4). This first cover member 26 is fixed to the retaining portion 21 via the four leg portions 26a in a state in which the first pinion gear portion 24, the first rotation restriction member 25, and the front dial 23 are positioned between the first cover member 26 and the retaining portion 21.

The first cover member 26 includes a shaft portion 26b protruding rearward at its center position. The shaft portion 26b of the first cover member 26 is coupled to the shaft portion 21b of the retaining portion 21 and they form a shaft in the front-rear direction together.

“Second Cover Member 27”

The second cover member 27 is also formed in a table shape having four leg portions 27a as in the first cover member 26. The second cover member 27 is fixed to the first cover member 26 via the four leg portions 27a.

“Presentation Portion 28”

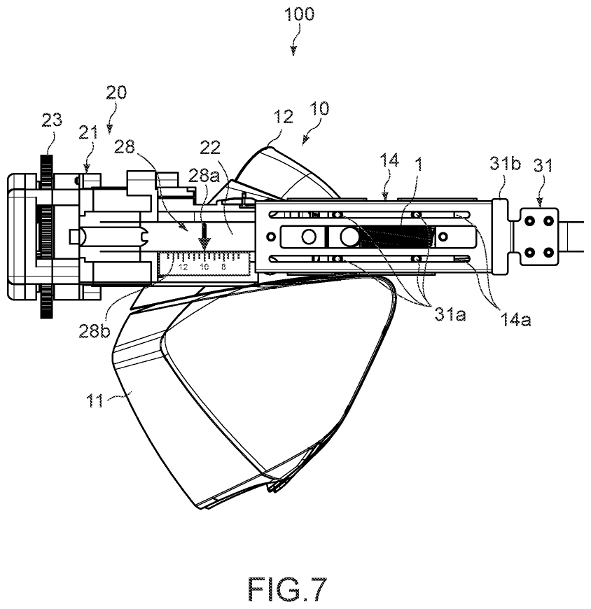

The adjustment mechanism 20 may include a presentation portion 28 for presenting the final clamping force F (final clamping force of the HMD 100 on the head) to the user. FIG. 7 is a diagram showing an example of the presentation portion 28. The presentation portion 28 includes an arrow-like mark 28a provided in the link member 22 and graduations 28b provided in the retaining portion 21. In the example shown in the figure, numbers such as “8”, “10”, and “12” are shown for the graduations 28b. These number indicates that the final clamping force F becomes 8 N, 10 N, or 12 N.

It should be noted that when the pair of link portions contract, the first spring members 1 extend, the initial tensile force F₀ increases, and the final clamping force F increases, and the arrow-like mark 28a provided in the link member 22 moves forward at this time. On the contrary, when the pair of link portions extend, the first spring members 1 contract, the initial tensile force F₀ decreases, and the final clamping force F decreases, the arrow-like mark 28a provided in the link member 22 moves rearward at this time.

In the example here, the numbers indicating the final clamping force F are used in the presentation portion 28. Instead of these numbers, letters such as “strong”, “middle”, and “weak” may be used. Typically, the presentation portion 28 can have any configuration as long as it is configured to enable the user to recognize what degree of strength the final clamping force F is.

[Band Portion 31]

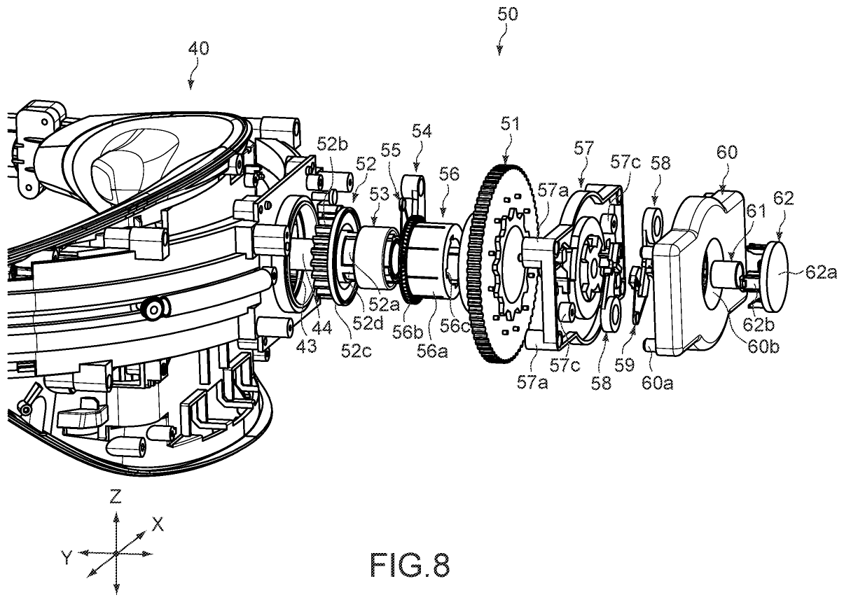

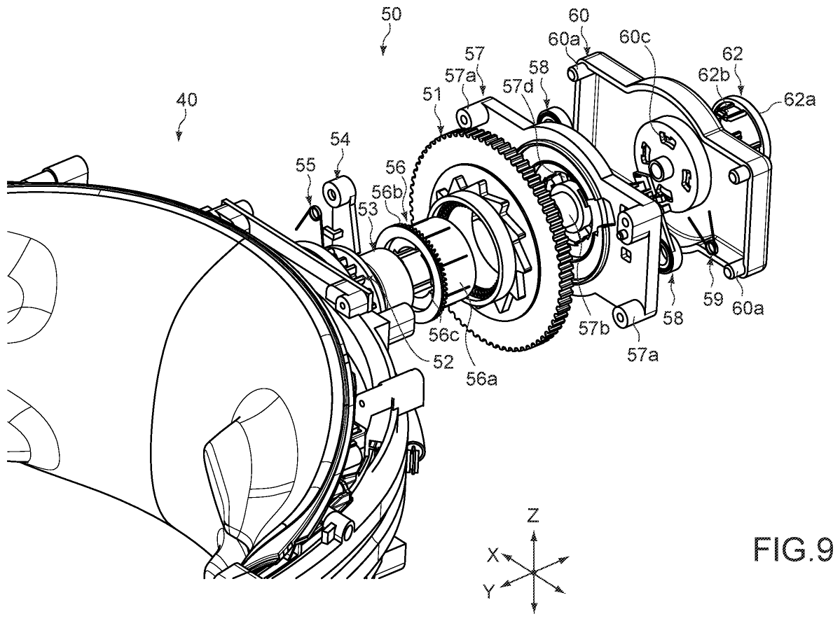

The pair of band portions 31 are each formed in a band shape long in one direction (see FIGS. 1, 2, and 7, and the like). Racks that are engaged with a second pinion gear 52b (see FIGS. 8 and 9 to be described later) of the extension and contraction mechanism 50 are provided in certain regions on the rear end sides of the band portions 31. On the other hand, the front end sides of the band portions 31 are fixed to the rear end sides of the first spring members 1.

On the sides of the front end sides of the band portions 31, a total of four protrusions 31a, two on the upper side and two on the lower side, which protrude outward, are provided. These four protrusions 31a can be guided through the two guide grooves 14a provided in the front-rear direction at the coupling portions 14, and accordingly the band portions 31 can be guided in the front-rear direction through the coupling portions 14.

Moreover, band stoppers 31b capable of being brought into contact with the rear end sides of the coupling portions 14 are provided on the front end sides of the band portions 31. These band stoppers 31b restrict the band portions 31 moving forward due to the initial tensile force of the first spring members 1 and fix the positions of the rear block 40 and the band portions 31.

A single protrusion 31c that protrudes outward is provided at a position near the middle in the longitudinal direction and the upper-lower direction of the band portion 31. This protrusion 31c can be guided through a guide groove 42a provided in a guide portion 42 of the rear block 40, and accordingly the band portion 31 can be guided in extension and contraction directions inside the rear block 40.

A front end side of a second spring member 2 is fixed to this protrusion 31c. It should be noted that the protrusion 31c has two functions, a function to be guided in the guide groove 42a and a function to fix one end of the second spring member 2.

[First Spring Member 1]

The first spring members 1 are provided between the front block 10 side and the pair of band portions (see FIGS. 1, 2, and 7, and the like). Specifically, the first spring member 1 is, on the front end side, fixed to the rear end side of the link member 22 and is, on the rear end side, fixed to the front end side of the band portion 31.

The first spring member 1 extends and contracts by the extension and contraction of the link member 22 according to the rotation of the front dial 23 so as to adjust the initial tensile force F₀. Moreover, the first spring members 1 are caused to extend by the constant amount t (see FIGS. 18 and 19 to be described later) and produce the final clamping force F by contraction of the pair of band portions 31 according to a rotation of a rear dial 51 to be described later.

In the present embodiment, the spring constant k per one of the first spring members 1 is 0.15 N/mm. It should be noted that the spring constant can be changed as appropriate.

[Second Spring Member 2]

The second spring members 2 are provided between the band portions 31 and the rear block 40. Specifically, the second spring member 2 is, on the front end side, fixed to the protrusion 31c of the band portion 31 and is, on the rear end side, fixed to a position near the middle in the left-right direction of the rear block 40.

Tensile force Fmax when the second spring member 2 extends at the maximum in the design is set to be smaller than initial tensile force F₀min of the first spring member 1 at the minimum in the design. That is, Fmax<F₀min. It will be described later in detail.

[Rear Block 40]

The rear block 40 includes therein a cushion portion 41 that is brought into contact with the back of the head (see FIG. 1 and the like). Moreover, the rear block 40 includes therein the pair of left and right guide portions 42 that guide the pair of band portions 31. The pair of guide portions 42 are provided to extend from the left and right end portion sides of the rear block 40 to the rear portion side and each have a thin plate shape long in one direction.

The guide portion 42 has the guide groove 42a at a position near the middle in the upper-lower direction, the guide groove 42a extending in the length direction (direction in which the mounting band 30 extends and contracts). The guide groove 42a is capable of being fitted to the protrusion 31c provided protruding outward on the band portions 31.

[Extension and Contraction Mechanism 50]

The extension and contraction mechanism 50 is provided on the side of the rear block 40 and causes the pair of band portions 31 to extend and contract with respect to the rear block 40 (see FIG. 1 and the like). This extension and contraction mechanism 50 is configured to be capable of causing the pair of band portions 31 to contract with respect to the rear block 40 by the constant amount t, so as to cause each of the pair of first spring members 1 in which the initial tensile force F₀ is produced to extend by the constant amount t (see FIGS. 18 and 19 to be described later).

The extension and contraction mechanism 50 includes a lock mechanism that switches an unlocked state to a locked state. Moreover, the extension and contraction mechanism 50 includes a cancel mechanism that switches the locked state to the unlocked state.

The unlocked state is a state in which the extension and contraction of the mounting band 30 that are performed in accordance with a relative movement between the rear block 40 and the pair of band portions 31 are freely performed. On the other hand, the locked state is a state in which the extension and contraction of the mounting band 30 that are not performed in accordance with the rotation of the rear dial 51 are restricted and the extension and contraction of the mounting band 30 that are performed in accordance with the rotation of the rear dial 51 are allowed.

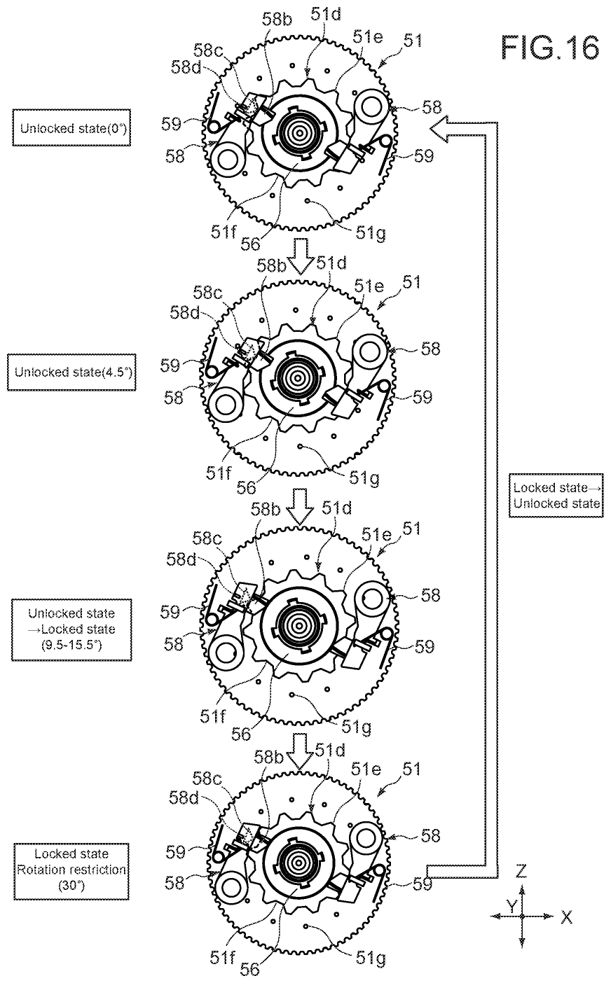

Moreover, the extension and contraction mechanism 50 includes a restriction mechanism that restricts the rotation of the rear dial 31 when the rear dial 51 is rotated by a constant angle θ in the clockwise direction (as viewed from the rear side: the first direction) corresponding to the direction in which the pair of band portions 31 contract. Typically, every time the locked state is switched to the unlocked state, the restriction mechanism restricts the rotation of the rear dial 51 in accordance with the rotation of the rear dial 51 by the constant angle θ from the position of the rear dial 51 at that time (see FIG. 16 to be described later).

The constant angle θ is a rotational angle of the rear dial 51 in the clockwise direction (as viewed from the rear side), which is required for causing each of the pair of band portions 31 to contract by the constant amount t with respect to the rear block 40 and causing each of the pair of first spring members 1 in which the initial tensile force F₀ is produced to extend by the constant amount t. Although the constant angle θ is 30 degrees in the present embodiment, this value can be changed as appropriate.

The restriction mechanism includes a normal rotation restriction portion and a reverse rotation restriction portion. The normal rotation restriction portion restricts the rotation (normal rotation) of the rear dial 51 in the clockwise direction (as viewed from the rear side) when the rear dial 51 is rotated by the constant angle θ. The reverse rotation restriction portion restricts the rotation (reverse rotation) of the rear dial 51 in the counter-clockwise direction (as viewed from the rear side) when the rear dial 51 is rotated by the constant angle θ.

FIG. 8 is an exploded perspective view as the respective parts of the extension and contraction mechanism 50 are viewed from the rear side. FIG. 9 is an exploded perspective view as the respective parts of the extension and contraction mechanism 50 are viewed from the front side.

As shown in FIGS. 8 and 9, the extension and contraction mechanism 50 includes a second pinion gear portion 52, a first biasing spring 53, a second rotation restriction member 54, a first torsion spring 55, a clutch 56, the rear dial 51, a first base member 57, a pair of lock levers 58, a pair of second torsion springs 59, a second base member 60, a second biasing spring 61, and a cancel button 62 in order from the front side.

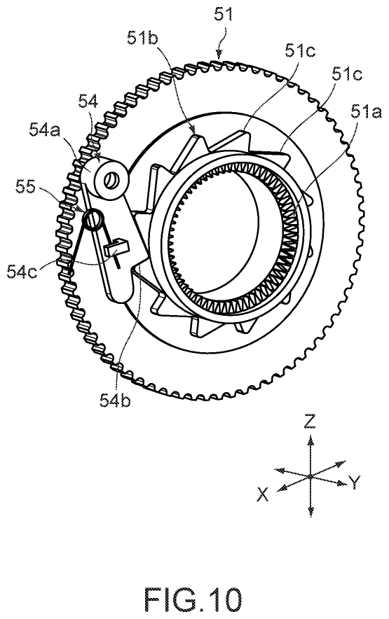

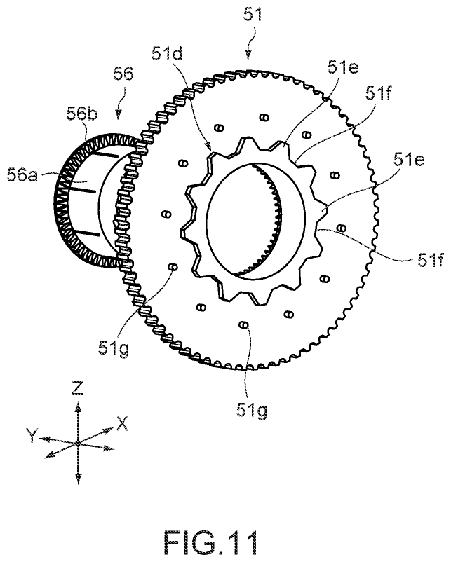

FIG. 10 is a perspective view as the rear dial 51 and the second rotation restriction member 54 are viewed from the front side. FIG. 11 is a perspective view as the rear dial 51 and the clutch 56 are viewed from the rear side.

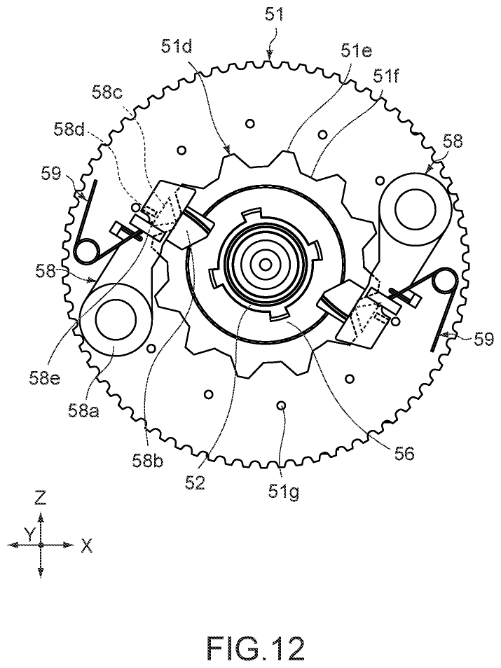

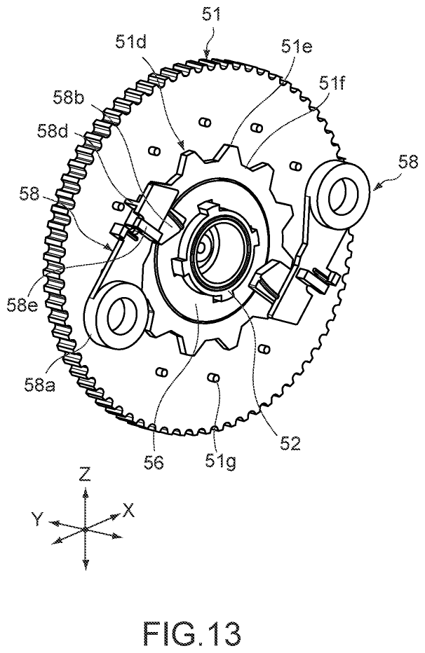

FIG. 12 is a diagram as the rear dial 51 and the pair of lock levers 58 are viewed from the rear side. FIG. 13 is a perspective view as the rear dial 51 and the lock levers 58 are viewed from the rear side.

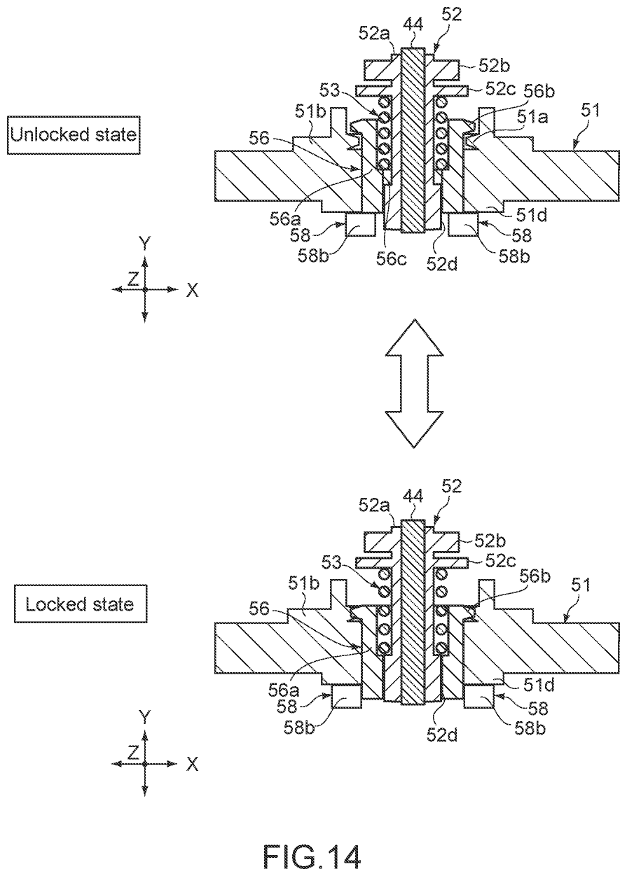

FIG. 14 is a schematic cross-sectional view of the respective parts of the extension and contraction mechanism 50 along a horizontal plane (XY-plane), which is a diagram showing switching between the unlocked state and the locked state.

It should be noted that in FIGS. 12 to 14, the first base member 57 interposed between the rear dial 51 and the pair of lock levers 58 is omitted.

Here, in the present embodiment, the second pinion gear portion 52, the clutch 56, the rear dial 51, and the like are configured to be rotatable around the front-rear axis and the expressions, clockwise and counter-clockwise, are used for rotations of the respective parts of the extension and contraction mechanism 50. For the sake of convenience, it is assumed that the expressions, clockwise and counter-clockwise, as rotation directions of the respective parts of the extension and contraction mechanism 50 mean rotation directions as viewed from the rear side.

It should be noted that the clockwise and counter-clockwise directions for rotations of the respective parts of the adjustment mechanism 20 described above mean the rotation directions as viewed from the front side. Therefore, it should be noted that the clockwise and counter-clockwise directions are opposite between the respective parts of the adjustment mechanism 20 and the respective parts of the extension and contraction mechanism 50.

“Opening, Etc. in Rear Block 40”

A circular opening 43 is provided near the middle in the left-right direction of a rear portion of the rear block 40 (in particular, see FIG. 8). The respective parts of the extension and contraction mechanism 50 are assembled and attached at the position of the opening 43.

The rear block 40 includes a shaft portion 44 extending in the front-rear direction at a center position of the opening 43. The shaft portion 44 is capable of rotatably supporting the second pinion gear portion 52, the clutch 56, and the rear dial 51 as the shaft.

“Second Pinion Gear Portion 52”

The second pinion gear portion 52 is configured to be rotatable in both the clockwise and counter-clockwise directions around the front-rear axis (see FIGS. 8, 9, and 14). The second pinion gear 52b includes a circular tube portion 52a, a second pinion gear 52b fixed to the outer periphery on the front side of the tube portion 52a, and a flange 52c fixed on the front side of the tube portion 52a and on a rear side of the second pinion gear 52b.

The tube portion 52a of the second pinion gear portion 52 is rotatable around the shaft portion 44 of the rear block 40. The tube portion 52a of the second pinion gear portion 52 includes a plurality of convex portions 52d extending in the front-rear direction at constant intervals in the circumferential direction on the outer circumferential surface. The plurality of convex portions 52d is capable of being fitted to a plurality of recess portions 56c provided in the clutch 56.

The second pinion gear 52b is capable of being engaged with racks provided in the pair of band portions 31 and is capable of causing the pair of band portions 31 to extend and contract by the rotation thereof. Although the second pinion gear 52b has a pitch circle diameter of Φ20 in the present embodiment, this value can be changed as appropriate.

The flange 52c is capable of locking the front end side of the first biasing spring 53 interposed between the second pinion gear portion 52 and the clutch 56.

“Clutch 56”

The clutch 56 is rotatable integrally with the second pinion gear portion 52 and is slidable in the front-rear direction with respect to the second pinion gear portion 52 (see FIGS. 8 and 9, FIGS. 11 and 14).

In the unlocked state, this clutch 56 is located at a non-working position (first position) not engaged with the rear dial 51 and allows the rotation of the second pinion gear portion 52 (see on the upper side of FIG. 14). Moreover, the clutch 56 moves from the non-working position to a working position (second position) to be engaged with the rear dial 51 in accordance with the rotation of the rear dial 51 in the unlocked state and switches the unlocked state to the locked state (see on the lower side of FIG. 14).

The clutch 56 includes a circular tube portion 56a, external tooth portions 56b like a gear provided in an outer circumferential surface on the front side of the tube portion 56a, and the plurality of recess portions 56c provided in an inner circumferential surface of the tube portion. The tube portion 56a of the clutch 56 is configured to have a diameter larger than that of the tube portion 52a of the second pinion gear portion 52 and the clutch 56 is mounted to cover the circumference of the second pinion gear portion 52.

The external tooth portions 56b are formed so as to protrude outward from the outer circumferential surface of the tube portion 56a. These external tooth portions 56b are capable of being engaged with internal tooth portions 51a provided in the rear dial 51. It should be noted that although the pitch of the external tooth portions 56b is 6 degrees in the present embodiment, this value can be changed as appropriate.

The plurality of recess portions 56c is formed so as to be depressed from an inner peripheral surface of the tube portion 56a. The plurality of recess portions 56c is formed extending in the front-rear direction at constant intervals in the circumferential direction. Since the plurality of recess portions 56c of the clutch 56 is engaged with the plurality of convex portions 52d of the second pinion gear portion 52, the clutch 56 is slidable in the front-rear direction with respect to the second pinion gear portion 52 while the rotation with respect to the second pinion gear portion 52 is restricted (i.e., rotatable integrally with the second pinion gear portion 52).

“First Biasing Spring 53”

The first biasing spring 53 is interposed between the second pinion gear portion 52 and the clutch 56 and is capable of biasing the clutch 56 rearward (toward the working position from the non-working position) (in particular, see FIGS. 8, 9, and 14). The front end side of the first biasing spring 53 is locked with the flange 52c of the second pinion gear portion 52 and the rear end side is locked with the clutch 56.

Although the springs are exemplified as the first biasing members that bias the clutch 56 rearward (toward the working position from the non-working position) in the description here, the first biasing members are not limited to the springs, and may be elastic materials such as rubbers. The same applies to the second biasing spring 61.

“Second Rotation Restriction Member 54”

The second rotation restriction member 54 is capable of locking a fitting rib 51b provided in the rear dial 51 and is capable of restricting, for each constant angle θ (30 degrees), the rotation (reverse rotation) of the rear dial 51 in the counter-clockwise direction (as viewed from the rear side) (see FIGS. 8, 9, and 10).

The second rotation restriction member 54 is rotatable in both the clockwise and counter-clockwise directions (as viewed from the rear side) around the front-rear axis. Moreover, the second rotation restriction member 54 is biased in the clockwise direction (as viewed from the rear side) by the first torsion spring 55.

The second rotation restriction member 54 includes a base end portion 54a and a leading end portion opposite to the base end portion 54a. The base end portion 54a is rotatably supported by the shaft portion provided in the rear block 40 as the shaft. A stopper hook 54b (second locking portion) capable of locking the fitting rib 51b (second engagement portion) of the rear dial 51 is provided in the leading end portion.

Moreover, a supporting portion 54c that supports the one end side of the first torsion spring 55 is provided at a position near the middle on the front surface side of the second rotation restriction member 54.

It should be noted that in the present embodiment, the fitting rib 51b provided in the rear dial 51 and the second rotation restriction member 54 constitute the reverse rotation restriction portion that restricts the reverse rotation (counter-clockwise) of the rear dial 51 (i.e., the restriction mechanism includes the fitting rib 51b provided in the rear dial 51 and the second rotation restriction member 54).

“First Torsion Spring 55”

The first torsion spring 55 is capable of biasing the second rotation restriction member 54 in the clockwise direction (as viewed from the rear side) (see FIGS. 8, 9, and 10).

The one end side of the first torsion spring 55 is supported by the supporting portion 54c provided in the second rotation restriction member 54 and the other end side of the first torsion spring 55 is supported by the supporting portion provided in the rear block 40.

“Rear Dial 51”

The rear dial 51 is capable of causing the pair of band portions 31 to extend and contract with respect to the rear block 40 by the rotation thereof (see FIGS. 7 to 14).

The rear dial 51 is rotatable in both the clockwise and counter-clockwise directions (as viewed from the rear side) around the front-rear axis. It should be noted that the counter-clockwise rotation of the rear dial 51 (as viewed from the rear side) is basically restricted by the second rotation restriction member 54. Moreover, as for the clockwise rotation (as viewed from the rear side), the rotation of the rear dial 51 for the constant angle θ (30 degrees) is allowed by the normal rotation restriction portion.

It should be noted that when the rear dial 51 is rotated in the clockwise direction (as viewed from the rear side), the pair of band portions 31 contract with respect to the rear block 40.

The rear dial 51 includes the internal tooth portions 51a like a gear at positions on the inner peripheral side on the front surface side. The internal tooth portions 51a are capable of being engaged with the external tooth portions 56b provided in the clutch 56. It should be noted that although the pitch of the internal tooth portions 51a is 6 degrees like the pitch of the external tooth portions 56b of the clutch 56 in the present embodiment, this value can be changed as appropriate.

Moreover, the rear dial 51 has the fitting rib 51b (second engagement portion) including a plurality of ribs 51c (tooth portions) like a gear at positions on the inner peripheral side (outside with respect to the internal tooth portions 51a) on the front surface side. The respective ribs 51c of the fitting rib 51b are formed for each constant angle θ (30 degrees) and are each capable of being locked with the stopper hook 54b of the second rotation restriction member 54.

Moreover, the rear dial 51 has an operation rib 51d including a plurality of ribs 51e like a gear at positions on the inner peripheral side on the back surface side. This operation rib 51d is capable of operating the lock levers 58 in accordance with the rotation (clockwise) of the rear dial 51. Specifically, the operation rib 51d is capable of moving the leading end sides of the lock levers 58 from inner peripheral positions (third position) to outer peripheral positions (fourth position) by rotating the lock levers 58 in the counter-clockwise direction (as viewed from the rear side) in accordance with the clockwise rotation of the rear dial 51 (as viewed from the rear side).

The respective ribs 51e of the operation rib 51d are formed for each constant angle θ (30 degrees) as in the ribs 51c of the fitting rib 51b. Moreover, a blank portion 51f in which no ribs 51e are provided is provided between the adjacent ribs 51e of the operation rib 51d. These blank portions 51f are provided for preventing the leading end sides of the lock levers 58 from immediately moving from the inner peripheral positions to the outer peripheral positions even when the rear dial 51 is rotated in the clockwise direction (as viewed from the rear side).

The ribs 51e of the operation rib 51d and the blank portions 51f are capable of being brought into contact with convex portions 58c provided in the lock levers 58.

Moreover, the rear dial 51 includes a plurality of protrusions 51g (first engagement portion) formed for each constant angle θ (30 degrees) in the circumferential direction on the back surface side. The plurality of protrusions 51g is provided so as to protrude rearward from the back surface of the rear dial 51.

The protrusions 51g are capable of being locked by stopper hooks 58d (first locking portion) provided on the leading end sides of the lock levers 58 when the leading end sides of the lock levers 58 are positioned at the outer peripheral position.

It should be noted that in the present embodiment, the plurality of protrusions 51g provided in the rear dial 51 and the stopper hooks 58d provided on the leading end sides of the lock levers 58 constitute the normal rotation restriction portion that restricts the normal rotation (clockwise) of the rear dial 51 (i.e., the restriction mechanism includes the plurality of protrusions 51g provided in the rear dial 51 and the stopper hooks 58d provided on the leading end sides of the lock levers 58).

“First Base Member 57”

The first base member 57 is formed in a table shape having four leg portions 57a (see FIGS. 7 and 8). This first base member 57 is fixed to the rear block 40 via the four leg portions 57a in a state in which the second pinion gear portion 52, the first biasing spring 53, the second rotation restriction member 54, the first torsion spring 55, the clutch 56, and the rear dial 51 are positioned between the first base member 57 and the rear block 40.

The first base member 57 includes a shaft portion 57b protruding forward at its center position on the front surface side. The shaft portion 57b of the first base member 57 is coupled to the shaft portion 44 of the rear block 40 and they form a shaft in the front-rear direction together.

The first base member 57 includes, on the back surface side, a pair of shaft portions 57c capable of rotatably supporting the pair of lock levers 58. Moreover, the first base member 57 includes, on the back surface side, a pair of supporting portions capable of supporting one end sides of a pair of torsion springs 45. Moreover, the first base member 57 includes a plurality of openings 57 through which a plurality of pushing protrusions 62b of the cancel button 62 is capable of being inserted.

“Lock Lever 58”

The lock levers 58 are paired at the left and right and have a shape long in one direction (in particular, see FIGS. 8 and 9, FIGS. 12 to 14). The lock levers 58 are capable of rotating in both the clockwise and counter-clockwise directions (as viewed from the rear side) around the front-rear axis. Moreover, the lock levers 58 are biased in the clockwise direction (as viewed from the rear side) by the second torsion spring 59.

The lock levers 58 includes a base end portion 58a and a leading end portion opposite to the base end portion 58a. The base end portion 58a is rotatably supported by the shaft portion 57c provided in the first base member 57. A stopper 58b, the convex portion 58c, and the stopper hook 58d are provided in the leading end portion in order from the inner peripheral side. Moreover, a supporting portion 58e that supports one end side of the second torsion spring 59 is provided on the back surface side of the lock lever 58.

In the unlocked state in which the rear dial 51 is not rotated, the stopper 58b is located at the inner peripheral position and restricts the movement (rearward movement) of the clutch 56 to the working position from the non-working position and positions the clutch 56 at the non-working position.

Moreover, in accordance with the rotation (clockwise) of the rear dial 51, the stopper 58b moves from the inner peripheral position to the outer peripheral position so as to cancel the restriction of the movement of the clutch 56 and moves the clutch 56 from the non-working position to the working position so as to switch the unlocked state to the locked state.

The convex portion 58c is provided on the front surface side on the leading end side of the lock lever 58. The convex portion 58c is capable of being brought into contact with each of the respective ribs 51e of the operation rib 51d and the blank portions 51f in the rear dial 51. In accordance with the clockwise rotation of the rear dial 51 (as viewed from the rear side), the convex portion 58c rotates the lock lever 58 in the counter-clockwise direction and moves the leading end side of the lock lever 58 (i.e., the stopper 58b and the stopper hook 58d) from the inner peripheral side to the outer peripheral position.

The stopper hook 58d is provided at the position closer to the outer periphery on the front surface side of the lock lever 58. In the locked state, the stopper hook 58d locks the protrusion 51g provided in the rear dial 51 when the leading end side of the lock lever 58 is positioned at the outer peripheral position, so as to restrict a clockwise rotation (as viewed from the rear side) of the rear dial 51 by an angle equal to or larger than the constant angle θ (30 degrees).

Moreover, when the cancel button 62 moves the clutch 56 from the working position to the non-working position (forward movement), the lock levers 58 rotate in the clockwise direction (as viewed from the rear side) with the biasing force of the second torsion spring 59. Accordingly, the lock levers 58 are capable of restricting the rearward movement of the clutch 56 through the stoppers 58b again. At this time, the locked state is switched to the unlocked state.

It should be noted that in the present embodiment, the lock mechanism includes the clutch 56, the second rotation restriction member 54, the fitting rib 51b and the operation rib 51d of the rear dial 51, the lock levers 58, and the like.

“Second Torsion Spring 59”

The second torsion spring 59 is provided for each lock lever 58 (see FIGS. 8, 9, and 12). The second torsion spring 59 is capable of biasing the lock levers 58 in the clockwise direction (as viewed from the rear side).

The one end side of the first torsion spring 55 is supported by the supporting portion 58e provided in the lock lever 58 and the other end side of the first torsion spring 55 is supported by the supporting portion provided in the first base portion.

“Second Base Member 60”

The second base member 60 is formed in a table shape having four leg portions 60a (see FIGS. 8 and 9). This second base member 60 is fixed to the first base member 57 via the four leg portions 60a in a state in which the lock levers 58 and the second torsion spring 59 are positioned between the second base member 60 and the first base member 57.

The second base member 60 includes a housing groove 60b capable of housing the cancel button 62. Moreover, the second base member 60 has a plurality of openings 60c through which the plurality of pushing protrusions 62b of the cancel button 62 is capable of being inserted. Moreover, the second base member 60 is capable of locking, on the back surface thereof, one end portion of the second biasing spring 61 interposed between the second base member 60 and the cancel button 62.

“Second Biasing Spring 61”

The second biasing spring 61 is interposed between the second base member 60 and the cancel button 62 and is capable of biasing the cancel button 62 rearward (see FIG. 8). The one end portion of the second biasing spring 61 is locked with the back surface of the second base portion and the other end portion of the second biasing spring 61 is locked with a front surface of a button main body 62a of the cancel button 62.

“Cancel Button 62”

The cancel button 62 (cancel mechanism) is movable in the front-rear direction in a state housed in the housing groove of the second base member 60 (see FIGS. 8 and 9). Moreover, the cancel button 62 is biased rearward by the second biasing spring 61.

The cancel button 62 includes the disk-shaped button main body 62a and the plurality of pushing protrusions 62b provided on the button main body 62a. The pushing protrusions 62b are provided so as to protrude forward at positions on the outer peripheral side on the front surface of the button main body 62a. The pushing protrusions 62b are provided at positions corresponding to the clutch 56 in the radial direction and are capable of moving the clutch 56 from the working position to the non-working position when the cancel button 62 moves forward.

The cancel button 62 is positioned on the rear side with the biasing force of the second biasing spring 61 in a state in which force is not applied to the cancel button 62. On the other hand, when force equal to or greater than the total value of the biasing force of the first biasing spring 53 and the biasing force of the second biasing spring 61 is applied to the cancel button 62 forward, the cancel button 62 moves forward, and when that force is cancelled, the cancel button 62 returns to the original position.

<Operation Description>

Next, an operation of the HMD 100 when the user wears the HMD 100 will be described.

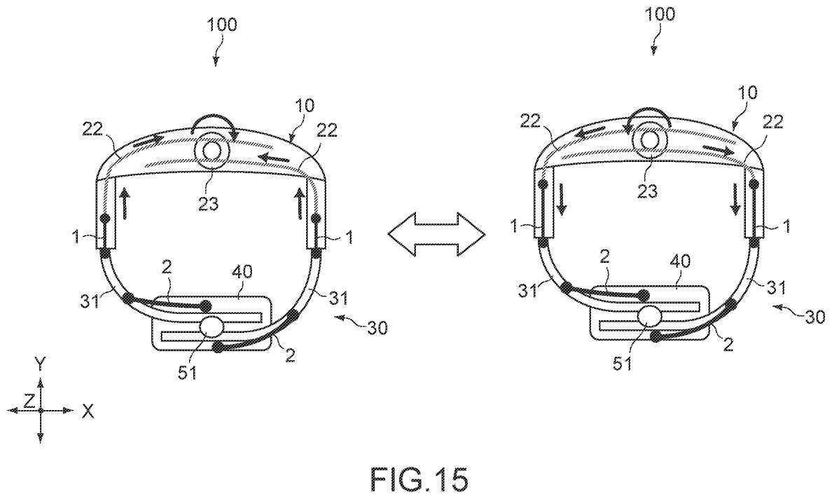

First of all, the user rotates the front dial 23 through the adjustment mechanism 20 so as to adjust the initial tensile force F₀ before the user wears the HMD 100 on the head. FIG. 15 is a diagram showing a state when the user is adjusting the initial tensile force F₀ by rotating the front dial 23 through the adjustment mechanism 20 before the user wears the HMD 100 on the head.

When the front dial 23 is rotated in the clockwise direction (as viewed from the front side), the front dial 23, the first rotation restriction member 25, and the first pinion gear portion 24 are integrally rotated in the clockwise direction, and accordingly, the pair of link members 22 contract. Accordingly, the pair of first spring members 1 extend and the initial tensile force F₀ increases.

On the contrary, when the front dial 23 is rotated in the counter-clockwise direction (as viewed from the front side), the front dial 23, the first rotation restriction member 25, and the first pinion gear portion 24 are integrally rotated in the counter-clockwise direction, and accordingly, the pair of link members 22 extend. Accordingly, the pair of first spring members 1 contract and the initial tensile force F₀ decreases.

Here, since the plurality of tooth portions 21c of the retaining portion 21 is formed at pitches of 15 degrees in the present embodiment, rest positions of the rotations of the front dial 23, the first rotation restriction member 25, and the first pinion gear portion 24 are at pitches of 15 degrees and they do not rest at any position other than these positions.

Moreover, since the first pinion gear 24b has a pitch circle diameter of Φ20 in the present embodiment, the amount of movement of the link member 22 per rotation of the front dial 23 or the like is 62.8 mm.

Moreover, since the spring constant k of the first spring members 1 is 0.15 N/mm in the present embodiment, an amount of change ΔF₀ of the initial tensile force F₀ per pitch is as follows.

ΔF₀=62.8×2×0.15/24=0.785 N≈0.08 kgf

That is, the initial tensile force F₀ of the first spring member 1 is variable for each 0.785 N 0.08 kgf) by rotation of the front dial 23. It should be noted that the value of ΔF₀ can be more finely adjusted if the number of tooth portions 21c of the retaining portion 21 is increased (if the pitches of the tooth portions 21c are reduced).

Moreover, the user adjusts the final clamping force F in accordance with the user's preference by rotating the front dial 23 while referring to the arrow-like mark 28a or the numbers shown in the graduations 28b in the presentation portion 28 of the adjustment mechanism 20 when rotating the front dial 23 (see FIG. 7).

It should be noted that when the pair of link portions contract (the initial tensile force F₀ and the final clamping force F increase) by rotation of the front dial 23, the arrow-like mark 28a provided in the link member 22 moves forward and the number indicated by the arrow increases. On the contrary, when the pair of link portions extend (the initial tensile force Fc and the final clamping force F decrease), the arrow-like mark 28a provided in the pair of link members 22 moves rearward and the number indicated by the arrow decreases.

Here, force in the direction to extend is constantly added to the pair of link members 22 due to the tensile force of the first spring members 1. On the other hand, the motion of the pair of link members 22 to extend is restricted by the first rotation restriction member 25 as the extension and contraction of the pair of link members 22 that are not performed in accordance with a rotation of the front dial 23.

[Unlocked State]

After adjusting the initial tensile force F₀ through the adjustment mechanism 20, the user wears the HMD 100 on the head. The state at this time is the unlocked state. In the unlocked state, the clutch 56 is located at the non-working position and the clutch 56 and the rear dial 51 are not associated with each other in the rotation direction. Therefore, in the unlocked state, the rotation of the pinion gear portion integral with the clutch 56 in the rotation direction is allowed.

Thus, in the unlocked state, the extension and contraction of the mounting band 30 due to the movement of the rear block 40 with respect to the pair of band portions 31 are possible. It should be noted that the pair of band portions 31 move equally on the left and right sides with respect to the rear block 40 due to the racks on the side of the pair of band portions 31 and the second pinion gear 52b on the side of the rear block 40 at this time, and therefore the mounting band 30 is capable of extending and contracting equally on the left and right sides.

When the user wears the HMD 100, the user holds the front block 10 in one hand and holds the rear block 40 in the other hand, and extends the entire HMD 100 slightly wider than the user's own head. Then, the user wears the HMD 100 on the head and releases the hands from the front block 10 and the rear block 40. At this time, with the tensile force of the second spring members 2, the length of the entire HMD 100 is automatically adjusted in the user's head size.

Hereinafter, the state in which the HMD 100 is mounted on the user's head in the unlocked state will be called temporary mounting for the sake of convenience.

Here, as described above, the tensile force Fmax when the second spring member 2 extends at the maximum in the design is set to be smaller than the minimum value F₀min of the initial tensile force F₀ of the first spring member 1 at the minimum in the design. That is, Fmax<F₀min.

Here, it is assumed that the user holds the front block 10 in one hand and holds the rear block 40 in the other hand, and extends the entire HMD 100 widely (extends it at the maximum in the design). At this time, the pair of band portions 31 are pulled rearward due to the tensile force of the second spring member 2, and accordingly, the first spring member 1 is pulled rearward.

At this time, since the relationship of Fmax<F₀min is established, the first spring member 1 does not extend and the initial tensile force F₀ of the first spring member 1 is maintained.

Now, a case where the first spring member 1 in which the initial tensile force F₀ is produced extends in the unlocked state will be assumed as a comparison. In this case, since the initial tensile force F₀ has varied and become an unknown number, when the first spring member 1 further extends by the constant amount t by the extension and contraction mechanism 50 thereafter, the final clamping force F also has varied and become an unknown number. In this case, the final clamping force F requested cannot be realized.

For this reason, in the present embodiment, Fmax<F₀min is established, the positional relationship between the front block 10 and the pair of band portions 31 are fixed in the unlocked state, and the first spring member 1 is prevented from extending due to force other than force caused by rotation of the front dial 23 in the unlocked state.

Moreover, in the unlocked state, the positional relationship between the front block 10 and the pair of band portions 31 are fixed and the front block 10 and the pair of band portions 31 can be considered to be integral. For this reason, in the unlocked state, the first spring members 1 do not work with the clamping force of the entire HMD 100 on the head. That is, in the unlocked state, only the second spring members 2 work, and for example, the clamping force of the HMD 100 during the temporary mounting is determined depending on the tensile force of the second spring members 2.

[Locked State]

After the temporary mounting, the user adjusts the HMD 100 so that the display unit of the front block 10 is located at a suitable position in the field of view. Thereafter, the user rotates the rear dial 51 in the clockwise direction (as viewed from the rear side). It should be noted that even if the user attempts to rotate the rear dial 51 in the counter-clockwise direction at this time, it does not rotate. It is because the ribs 51c of the fitting rib 51b of the rear dial 51 are locked by the stopper hook 54b of the second rotation restriction member 54.

FIG. 16 is a diagram showing states of the rear dial 51, the lock levers 58, and the like when the rear dial 51 is rotated in the clockwise direction (as viewed from the rear side).

Referring to the top diagram in FIG. 16, when the HMD 100 is temporarily mounted, the stoppers 58b of the lock levers 58 are located at the inner peripheral position and the stoppers 58b restrict the rearward movement of the clutch 56. That is, at this time, the HMD 100 is in the unlocked state. Moreover, at this time, the counter-clockwise rotation of the rear dial 51 (as viewed from the rear side) is restricted by the second rotation restriction member 54. The position of the rear dial 51 in the rotation direction at this time is set as a reference position (0 degrees).

Referring to the second diagram from the top in FIG. 16, when the rear dial 51 is rotated by 4.5 degrees in the clockwise direction (as viewed from the rear side) from the state in which the rear dial 51 is at the reference position (0 degrees), the convex portions 58c of the lock levers 58 are brought into contact with the ribs 51e of the operation rib 51d of the rear dial 51. By bringing the convex portions 58c of the lock levers 58 into contact with the ribs 51e of the operation rib 51d, the counter-clockwise rotation of the lock levers 58 (as viewed from the rear side) is started.

Here, the convex portions 58c of the lock levers 58 are not in contact with the ribs 51e of the operation rib 51d and are in contact with the blank portions 51f of the operation rib 51d until the rear dial 51 is rotated by 4.5 degrees from the reference position. For this reason, the lock levers 58 do not start to rotate in the counter-clockwise direction (as viewed from the rear side) until the rear dial 51 is rotated by 4.5 degrees from the reference position.

A case where the rotation of the lock levers 58 is started immediately after the clockwise rotation of the rear dial 51 (as viewed from the rear side) is started will be assumed. In this case, the stopper hooks 58d of the lock levers 58 interfere with the protrusions 51g of the rear dial 51, and the rotation of the rear dial 51 is restricted immediately after the rotation of the rear dial 51 is started.

For this reason, in the present embodiment, the blank portions 51f in which no ribs 51e are provided are provided in the operation rib 51d of the rear dial 51, and the rotation of the lock levers 58 is configured to start, delayed a bit from the start of the rotation of the rear dial 51 by these blank portions 51f. That is, these blank portions 51f enable the stopper hooks 58d of the lock levers 58 to pass through the protrusions 51g of the rear dial 51 (the protrusions 51g used in the previous cycle).

Referring to the third diagram from the top in FIG. 16, when the rear dial 51 is further rotated by 4.5 degrees and rotated by 9.5 degrees from the reference position, the stoppers 58b of the lock levers 58 move to the outer peripheral positions. Accordingly, the restriction of the rearward movement of the clutch 56 through the stoppers 58b is cancelled.

When the rearward movement of the clutch 56 is cancelled, the clutch 56 moves from the non-working position to the working position due to the first biasing spring 53 so as to switch the unlocked state to the locked state.

It should be noted that as for the switching from the unlocked state to the locked state, a variation is caused in a range of 9.5 degrees to 15.5 degrees, i.e., a range of 6 degrees from the reference position in terms of the rotational angle of the rear dial 51. It is because, as described above, the external tooth portions 56b on the side of the clutch 56 and the internal tooth portions 51a of the rear dial 51 are each configured at pitches of 6 degrees.

That is, although the restriction of the rearward movement of the clutch 56 through the lock levers 58 is cancelled if the rear dial 51 is rotated by 9.5 degrees from the reference position, the clutch 56 does not move rearward unless the external tooth portions 56b of the clutch 56 mesh with the internal tooth portions 51a of the rear dial 51. For this reason, the switching from the unlocked state to the locked state varies in the range of 6 degrees in association with the pitches of the external tooth portions 56b of the clutch 56 and the internal tooth portions 51a of the rear dial 51.

It should be noted that if the pitches of the external tooth portions 56b of the clutch 56 and the internal tooth portions 51a of the rear dial 51 are set to be much smaller, this variation itself decreases, but the strength of the external tooth portions 56b of the clutch 56 and the internal tooth portions 51a of the rear dial 51 decreases. Therefore, it is sufficient to set the pitches of the external tooth portions 56b of the clutch 56 and the internal tooth portions 51a of the rear dial 51 as appropriate considering necessary torque.

Moreover, the clutch 56 using fitting of the tooth portions as in the present embodiment may be replaced by a friction clutch that is fitted to the rear dial 51 at an arbitrary position. In this case, such a variation becomes zero theoretically, but it is necessary to consider necessary torque also in this case.

Referring to the bottom diagram in FIG. 16, the rear dial 51 is further rotated after the unlocked state is switched to the locked state. Since the stoppers 58b of the lock levers 58 are brought into contact with the outer circumferential surface of the clutch 56 at this time, the leading end sides of the lock levers 58, i.e., the stopper hooks 58d of the lock levers 58 are located at the outer peripheral positions.

When the rear dial 51 is rotated by 30 degrees from the reference position (0 degrees), the stopper hooks 58d of the lock levers 58 located at the outer peripheral positions lock the protrusions 51g of the rear dial 51 so that the clockwise rotation of the rear dial 51 is restricted.

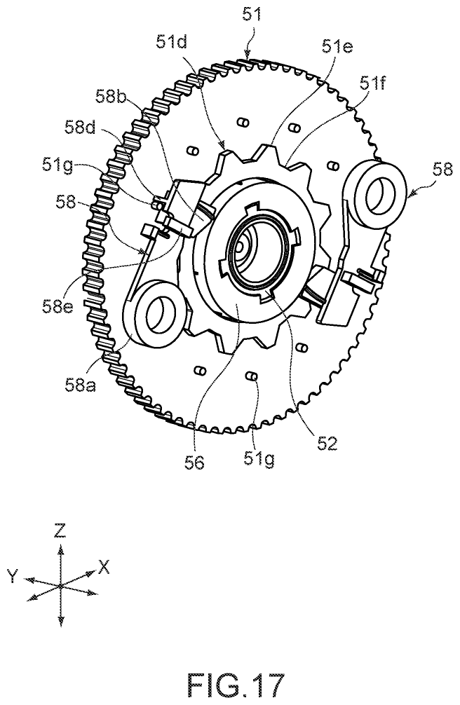

FIG. 17 is a perspective view from the rear side, showing a state when the stopper hooks 58d of the lock levers 58 lock the protrusions 51g of the rear dial 51.

In addition, since the stopper hook 54b of the second rotation restriction member 54 locks the fitting rib 51b of the rear dial 51 on the front side of the rear dial 51 at this time, the counter-clockwise rotation of the rear dial 51 is also restricted (see FIG. 10).

When the user pushes the cancel button 62 from the state shown in the bottom diagram in FIG. 16, the cancel button 62 moves the clutch 56 forward so that the clutch 56 is moved from the working position to the non-working position. At this time, due to the forward movement of the clutch 56, the lock levers 58 rotate in the clockwise direction (as viewed from the rear side) with the biasing force of the second torsion spring 59.

Accordingly, the stoppers 58b of the lock levers 58 restrict the rearward movement of the clutch 56 and the locked state is switched to the unlocked state. Accordingly, it returns to the state of the bottom diagram in FIG. 16. That is, the rear dial 51 returns to the reference position (0 degrees). Thereafter, the operation described with reference to FIG. 16 is repeated for every 30 degrees.

[Extension of First Spring Member 1 by Constant Amount t]

FIG. 18 is a schematic diagram as a state when the pair of first spring members 1 are caused to extend by the constant amount t is viewed from above the HMD 100. FIG. 19 is a side view of the HMD 100, showing a state when the pair of first spring members 1 are caused to extend by the constant amount t.

The user rotates the rear dial 51 in the clockwise direction (as viewed from the rear side) after temporary mounting the HMD 100. As described above, the unlocked state is switched to the locked state when the rear dial 51 is at 9.5 degrees to 15.5 degrees from the reference position (0 degrees).

When the unlocked state is switched to the locked state, the rear dial 51, the clutch 56, and the second pinion gear portion 52 rotate integrally. Therefore, when the rear dial 51 is further rotated in the clockwise direction (as viewed from the rear side) after the unlocked state is switched to the locked state, the second pinion gear portion 52 accordingly rotates in the clockwise direction, and the pair of band portions 31 contract with respect to the rear block 40.

Thereafter, the rotation of the rear dial 51 is restricted when the rear dial 51 is rotated by 30 degrees in the clockwise direction (as viewed from the rear side) from the reference position.

Here, a rotational angle of the second pinion gear 52b in the clockwise direction (as viewed from the rear side) corresponds to an angle until the rotation of the rear dial 51 is restricted after the state is switched to the locked state. Therefore, the rotational angle of the second pinion gear 52b in the clockwise direction is 14.5 degrees to 20.5 degrees (=30 degrees-9.5 to 15.5 degrees). That is, the rotational angle of the second pinion gear 52b in the clockwise direction is 17.5±3 degrees.

In the present embodiment, the second pinion gear 52b has a pitch circle diameter of Φ20, and an amount of movement of the band portion 31 when the second pinion gear 52b is rotated once (360 degrees) is 62.8 mm. Since the rotational angle per operation of the second pinion gear 52b is 17.5±3 degrees, the amount of movement of the band portion 31 per operation is 3.05±0.52 mm (=62.8×(17.5±3)/360).

That is, when the rear dial 51 is rotated by 30 degrees, the pair of band portions 31 each contract with respect to the rear block 40 by 3.05±0.52 mm.

Here, when the rear dial 51 is rotated in the clockwise direction (as viewed from the rear side) in a state in which the HMD 100 is mounted on the head, the pair of band portions 31 contract with respect to the rear block 40 while the positional relationship between the front block 10 and the rear block 40 remains fixed. Therefore, when the band portions 31 contract with respect to the rear block 40, the front end sides of the band portions 31 move rearward by the same amount as the length t by which the band portions 31 contract.

At this time, a gap having the same distance t as the length t by which the band portions 31 contract is formed between the rear end portions of the coupling portions 14 in the front block 10 and the band stoppers 31b on the front end sides of the band portions 31. Then, the first spring members 1 in which the initial tensile force F₀ is produced is caused to extend by the same amount (constant amount t) as the length t by which the band portions 31 contract.

It should be noted that (1) the length t by which the band portions 31 contract by the rotation of the rear dial 51 by 30 degrees (constant angle θ), (2) the distance t of the gap between the rear end portions of the coupling portions 14 of the front block 10 and the band stoppers 31b on the front end sides of the band portions 31, and (3) the length t (i.e., the constant amount t) by which the first spring members 1 in which the initial tensile force F₀ is produced is further caused to extend are the same value.

Here, the final clamping force F (final clamping force applied to the head) is expressed in accordance with the following expression using the spring constant k per one of the first spring members 1, the initial tensile force F₀, and the constant amount t (the length by which the first spring members 1 in which the initial tensile force F0 is produced are caused to extend).

F=2F₀+2kt

The spring constant k and the constant amount t are constants determined in advance in the design, and therefore the final clamping force F is determined depending on the initial tensile force F₀ adjusted by the user.

It should be noted that since the pair of second spring members 2 do not work with the clamping force on the head in the locked state, they are not associated with the final clamping force F.

It will be described. The pair of second spring members 2 constantly produce force to pull the rear block 40 and the pair of band portions 31 and cause the mounting band 30 to contract. On the other hand, when the unlocked state shifts to the locked state, the second pinion gear 52b, the clutch 56, and the rear dial 51 become integral in the rotation direction.

Since the racks of the pair of band portions 31 and the second pinion gear 52b mesh with each other, the pair of band portions 31 do not extend and contract with respect to the front block 10 in the locked state unless the rear dial 51 rotates. That is, since the extension and contraction of the pair of band portions 31 through the pair of second spring members 2 are, in the locked state, restricted as the extension and contraction that are not performed in accordance with the rotation of the rear dial 51, the pair of second spring members 2 do not work in the locked state.

Here, as described above in the present embodiment, the band portions 31 contract with respect to the rear block 40 by 3.05±0.52 mm (constant amount t) when the rear dial 51 is rotated by 30 degrees (constant angle θ). Moreover, in the present embodiment, the spring constant k of the first spring member 1 is 0.15 N/mm. Moreover, as an example, it is assumed that the initial tensile force F₀ is 4.54 N (median of the initial tensile force). The above-mentioned expression, F=2F₀+2kt, becomes as follows by substituting it into the expression.

F=2F₀+2kt=2×4.54+2×0.15×3.05≈10 N

At this time, a variation of ±0.52×2×0.15=±0.156 N is caused. This variation is caused due to the pitches (time when the clutch 56 operates) of the external tooth portions 56b of the clutch 56 and the internal tooth portions 51a of the rear dial 51. Therefore, the variation can be reduced by further reducing the pitches of the external tooth portions 56b of the clutch 56 and the internal tooth portions 51a of the rear dial 51.

In the present embodiment, the presentation portion 28 as shown in FIG. 7 is provided in order to visualize and present the final clamping force F (here, 10 N) shown in the above-mentioned expression to the user. FIG. 7 shows the graduations 28b marked with the numbers indicating the final clamping force F, using the final clamping force F of 10 N as the median.

<Actions, Etc.>

As described above, in the present embodiment, the user can adjust the initial tensile force F₀ of the first spring member 1 in a state in which the positions of the front block 10 and the pair of band portions 31 are fixed by using the adjustment mechanism 20. Therefore, the user can adjust the final clamping force F in advance. Therefore, the HMD 100 according to the present embodiment can be mounted on the head with suitable clamping force F.

Moreover, in the present embodiment, the user can cause to contract the pair of band portions 31 with respect to the rear block 40 by the constant amount t by using the extension and contraction mechanism 50. Therefore, the user can cause the pair of first spring members 1 in which the initial tensile force is produced to extend by the constant amount t. Accordingly, since the final clamping force F is determined, anyone can put the HMD 100 on the head with suitable clamping force irrespective of the user's head size. That is, fearing that the HMD 100 may fall down, the user does not increase the clamping force of the HMD 100 unnecessarily.

Moreover, in the present embodiment, the user can easily adjust the initial tensile force F₀ by rotating the front dial 23 of the adjustment mechanism 20. At this time, since the presentation portion 28 of the adjustment mechanism 20 presents the final clamping force F to the user, the user can easily set desired final clamping force F.

Moreover, in the present embodiment, in the adjustment mechanism 20, the first rotation restriction member 25 restricts the extension and contraction of the pair of link members 22 that are not performed in accordance with a rotation of the front dial 23. Therefore, since the extension of the pair of link members 22 through the pair of first spring members 1 and the contraction of the pair of spring members are restricted during non-rotation of the front dial 23, the initial tensile force F₀ of the pair of spring members can be suitably maintained.

Moreover, in the present embodiment, the user can easily set the clamping force of the HMD 100 to be the final clamping force F by the rotation of the rear dial 51 of the extension and contraction mechanism 50.

At this time, when the rear dial 51 is rotated by the constant angle θ (30 degrees), the normal rotation restriction portion (the plurality of protrusions 51g of the rear dial 51 and the stopper hooks 58d of the lock levers 58) restricts the clockwise rotation of the rear dial 51 (as viewed from the rear side). Moreover, at this time, the reverse rotation restriction portion (the fitting rib 51b of the rear dial 51 and the second rotation restriction member 54) restricts the counter-clockwise rotation of the rear dial 51 (as viewed from the rear side). Accordingly, the final clamping force F of the HMD 100 can be maintained.

Moreover, in the present embodiment, every time the locked state is switched to the unlocked state, the rotation of the rear dial 51 is restricted in accordance with the rotation of the rear dial 51 by the constant angle θ (30 degrees) from the position of the rear dial 51 (the reference position (0 degrees)) at that time (see FIG. 16). Therefore, in the present embodiment, it becomes possible to repeat the same operation for each constant angle θ (30 degrees), and for example, the user's operations such as returning the rear dial 51 to the original position become unnecessary.

Moreover, in the present embodiment, the blank portion 51f is provided between the rib 51e and the rib 51e in the operation rib 51d provided on the back surface side of the rear dial 51. Accordingly, it is possible to prevent the situation where the lock levers 58 rotate immediately after the rotation of the rear dial 51 and the stopper hooks 58d of the lock levers 58 interfere with the protrusions 51g provided in the rear dial 51.

Moreover, in the present embodiment, the tensile force Fmax when the second spring member 2 extends at the maximum in the design is set to be smaller than the minimum value F₀min of the initial tensile force F₀ of the first spring members 1 in the design (i.e., Fmax<F₀min). Accordingly, in the unlocked state, the positional relationship between the front block 10 and the pair of band portions 31 can be fixed, and the initial tensile force F₀ and the final clamping force F can be prevented from fluctuating.

### Various Modified Examples

The present technology can also take the following configurations.

(1) A head-mounted device, including:

a front block that is mounted on a front side of a head;

a mounting band that has a rear block that is mounted on a rear side of the head and a pair of band portions that are mounted on left and right sides of the head and are capable of extending and contracting by relative movement between the rear block and the pair of band portions;

a pair of left and right first elastic members provided between the front block and the pair of band portions; and

an adjustment mechanism that is provided in the front block and adjusts initial tensile force of the pair of first elastic members by causing the pair of first elastic members to extend and contract in a state in which positions of the front block and the pair of band portions are fixed.

(2) The head-mounted device according to (1), in which

the adjustment mechanism includes a first dial capable of adjusting the initial tensile force by rotation thereof.

(3) The head-mounted device according to (2), in which

the adjustment mechanism includes a pair of left and right link members that are capable of extending and contracting by rotation of the first dial and adjust the initial tensile force by the extension and contraction.

(4) The head-mounted device according to (3), in which

the first elastic member is, on one end side, fixed to the link member and is, on another end side, fixed to the band portion.

(5) The head-mounted device according to (3) or (4), in which

the adjustment mechanism further includes a restriction member that allows the extension and contraction of the pair of link members, which are caused by rotation of the first dial, and restricts the extension and contraction of the pair of link members, which are not caused by rotation of the first dial.

(6) The head-mounted device according to any one of (1) to (5), further including

an extension and contraction mechanism that is provided in the rear block and is for causing the pair of band portions to extend and contract with respect to the rear block.

(7) The head-mounted device according to (6), in which

the extension and contraction mechanism is configured to be capable of causing the pair of band portions to contract with respect to the rear block by a constant amount, thereby causing the pair of first elastic members in which the initial tensile force is produced to extend by the constant amount.

(8) The head-mounted device according to (7), in which

the extension and contraction mechanism includes a second dial that causes the pair of band portions to extend and contract by rotation thereof.

(9) The head-mounted device according to (8), in which

the extension and contraction mechanism further includes a restriction mechanism that restricts rotation of the second dial when the second dial is rotated by a constant angle corresponding to the constant amount in a first direction corresponding to a direction in which the pair of band portions contract.

(10) The head-mounted device according to (9), in which

the extension and contraction mechanism includes a lock mechanism that switches an unlocked state in which the extension and contraction of the mounting band are freely performed to a locked state in which the extension and contraction of the mounting band, which are not caused by rotation of the second dial, are restricted and the extension and contraction of the mounting band, which are caused by rotation of the second dial, are allowed.

(11) The head-mounted device according to (10), in which

the lock mechanism switches the unlocked state to the locked state in accordance with a rotation of the second dial.

(12) The head-mounted device according to (11), in which

the extension and contraction mechanism includes a cancel mechanism that switches the locked state to the unlocked state.

(13) The head-mounted device according to (12), in which

the restriction mechanism restricts, every time the locked state is switched to the unlocked state, rotation of the second dial in accordance with a rotation of the second dial by the constant angle from a position of the second dial at that time.

(14) The head-mounted device according to (13), in which

the restriction mechanism includes a normal rotation restriction portion that restricts rotation of the second dial in the first direction when the second dial is rotated by the constant angle.

(15) The head-mounted device according to (13) or (14), in which

the restriction mechanism includes a reverse rotation restriction portion that restricts rotation of the second dial in a second direction opposite to the first direction when the second dial is rotated by the constant angle.

(16) The head-mounted device according to (14), in which

the lock mechanism includes
a clutch movable between a first position and a second position, and
a lock lever that is movable between a third position and a fourth position in accordance with a rotation of the second dial and that is located at the third position in the unlocked state so as to restrict movement of the clutch from the first position to the second position and positions the clutch at the first position, moves from the third position to the fourth position in accordance with a rotation of the second dial so as to cancel the restriction, and moves the clutch from the first position to the second position so as to switch the unlocked state to the locked state.
   (17) The head-mounted device according to (16), in which

the normal rotation restriction portion includes
a first engagement portion provided in the second dial for each constant angle, and
a first locking portion that is provided in the lock lever and locks the first engagement portion when the lock lever is located at the fourth position.
   (18) The head-mounted device according to (15), in which

the reverse rotation restriction mechanism includes
a second engagement portion that is provided in the dial and has a plurality of tooth portions each corresponding to the constant angle, and
a second locking portion capable of locking the second engagement portion.
   (19) The head-mounted device according to any one of (1) to (18), further including
a pair of left and right second elastic members provided between the rear block and the pair of band portions.
   (20) The head-mounted device according to (19), in which
tensile force when the second elastic member extends at the maximum is smaller than the initial tensile force.

### REFERENCE SIGNS LIST

1 first spring member
2 second spring member
10 front block
20 adjustment mechanism
30 mounting band
31 band portion
40 rear block
50 extension and contraction mechanism
100 HMD

1. A head-mounted device, comprising:
a front block that is mounted on a front side of a head;
a mounting band that has a rear block that is mounted on a rear side of the head and a pair of band portions that are mounted on left and right sides of the head and are capable of extending and contracting by relative movement between the rear block and the pair of band portions;
a pair of left and right first elastic members provided between the front block and the pair of band portions; and
an adjustment mechanism that is provided in the front block and adjusts initial tensile force of the pair of first elastic members by causing the pair of first elastic members to extend and contract in a state in which positions of the front block and the pair of band portions are fixed.

2. The head-mounted device according to claim 1, wherein
the adjustment mechanism includes a first dial capable of adjusting the initial tensile force by rotation thereof.

3. The head-mounted device according to claim 2, wherein
the adjustment mechanism includes a pair of left and right link members that are capable of extending and contracting by rotation of the first dial and adjust the initial tensile force by the extension and contraction.

4. The head-mounted device according to claim 3, wherein
the first elastic member is, on one end side, fixed to the link member and is, on another end side, fixed to the band portion.

5. The head-mounted device according to claim 3, wherein
the adjustment mechanism further includes a restriction member that allows extension and contraction of the pair of link members, which are caused by rotation of the first dial, and restricts extension and contraction of the pair of link members, which are not caused by rotation of the first dial.

6. The head-mounted device according to claim 1, further comprising
an extension and contraction mechanism that is provided in the rear block and is for causing the pair of band portions to extend and contract with respect to the rear block.

7. The head-mounted device according to claim 6, wherein
the extension and contraction mechanism is configured to be capable of causing the pair of band portions to contract with respect to the rear block by a constant amount, thereby causing the pair of first elastic members in which the initial tensile force is produced to extend by the constant amount.

8. The head-mounted device according to claim 7, wherein
the extension and contraction mechanism includes a second dial that causes the pair of band portions to extend and contract by rotation thereof.

9. The head-mounted device according to claim 8, wherein
the extension and contraction mechanism further includes a restriction mechanism that restricts rotation of the second dial when the second dial is rotated by a constant angle corresponding to the constant amount in a first direction corresponding to a direction in which the pair of band portions contract.

10. The head-mounted device according to claim 9, wherein
the extension and contraction mechanism includes a lock mechanism that switches an unlocked state in which extension and contraction of the mounting band are freely performed to a locked state in which extension and contraction of the mounting band, which are not caused by rotation of the second dial, are restricted and extension and contraction of the mounting band, which are caused by rotation of the second dial, are allowed.

11. The head-mounted device according to claim 10, wherein
the lock mechanism switches the unlocked state to the locked state in accordance with a rotation of the second dial.

12. The head-mounted device according to claim 11, wherein
the extension and contraction mechanism includes a cancel mechanism that switches the locked state to the unlocked state.

13. The head-mounted device according to claim 12, wherein
the restriction mechanism restricts, every time the locked state is switched to the unlocked state, rotation of the second dial in accordance with a rotation of the second dial by the constant angle from a position of the second dial at that time.

14. The head-mounted device according to claim 13, wherein
the restriction mechanism includes a normal rotation restriction portion that restricts rotation of the second dial in the first direction when the second dial is rotated by the constant angle.

15. The head-mounted device according to claim 13, wherein
the restriction mechanism includes a reverse rotation restriction portion that restricts rotation of the second dial in a second direction opposite to the first direction when the second dial is rotated by the constant angle.

16. The head-mounted device according to claim 14, wherein
the lock mechanism includes
a clutch movable between a first position and a second position, and
a lock lever that is movable between a third position and a fourth position in accordance with a rotation of the second dial and that is located at the third position in the unlocked state so as to restrict movement of the clutch from the first position to the second position and positions the clutch at the first position, moves from the third position to the fourth position in accordance with a rotation of the second dial so as to cancel the restriction, and moves the clutch from the first position to the second position so as to switch the unlocked state to the locked state.

17. The head-mounted device according to claim 16, wherein
the normal rotation restriction portion includes
a first engagement portion provided in the second dial for each constant angle, and
a first locking portion that is provided in the lock lever and locks the first engagement portion when the lock lever is located at the fourth position.

18. The head-mounted device according to claim 15, wherein
the reverse rotation restriction portion includes
a second engagement portion that is provided in the second dial and has a plurality of tooth portions each corresponding to the constant angle, and
a second locking portion capable of locking the second engagement portion.

19. The head-mounted device according to claim 1, further comprising
a pair of left and right second elastic members provided between the rear block and the pair of band portions.

20. The head-mounted device according to claim 19, wherein
tensile force when the second elastic member extends at the maximum is smaller than the initial tensile force.
